(19) United States
(12) Patent Application Publication
(10) Pub. No.: US 2006/0048659 A1
(43) Pub. Date: Mar. 9, 2006

(54) Covering for architectural surfaces and method of forming and applying same

(75) Inventors: Wendell B Colson, Weston, MA (US); Daniel M Fogarty, Framingham, MA (US); David P Hartman, Framingham, MA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., New Jersey (US)

(21) Appl. No.: 10/541,963

(22) PCT Filed: Jan. 13, 2004
(86) PCT No.: PCT/US04/00752

§ 371 Date: Jul. 12, 2005

Related U.S. Application Data
(60) Provisional application No. 60/440,826, filed on Jan. 16, 2003.
(60) Provisional application No. 60/440,825, filed on Jan. 16, 2003.

(51) Int. Cl. B41F 3/04

(52) U.S. Cl. 101/272

(57) ABSTRACT

A covering for architectural surfaces as well as a method of forming and applying the covering is described in various embodiments and arrangements wherein fabric can be utilized and folded to provide a three-dimensional appearance with hollow or padded cells and wherein folds in the material used to make the covering or reveal strips conceal otherwise distractive seams between adjacent strips of the covering material.

### CROSS REFERENCE TO RELATED APPLICATIONS

The present application is related to, claims priority to, and incorporates by reference the subject matter of U.S. provisional application Nos. 60/440,825 filed 16 Jan. 2003 and 60/440,826 filed 16 Jan. 2003.

### BACKGROUND OF THE INVENTION

1. Field of the Invention

The present invention relates generally to coverings for architectural surfaces such as walls, ceilings, and the like, and more specifically to a cellular covering which may have a base sheet with a top overlying or facing layer of fabric or the like having folds therein to define cells between the overlying layer and the base sheet and a method of forming and applying the covering. The cells can be hollow or filled with other materials for decorative and/or acoustical purposes.

2. Description of the Relevant Art

For many years, architectural surfaces such as walls, ceilings, and the like have been treated to cover the structural surfaces with materials that are aesthetically more pleasing and/or for acoustical control. Common forms of coverings include paint, wood paneling, acoustical panels, wallpaper, and the like. Wallpaper itself has come in numerous forms and patterns and may be installed in different ways.

A typical wallpaper has a base flexible paper material on which graphics are printed in various patterns and colors. The wallpaper typically comes in rolls and is adhered to the architectural surface with a wet adhesive which is preapplied to the architectural surface prior to mounting the wallpaper. The wet surface, of course, allows the paper to be adjusted on the surface so that lateral edges of adjacent sheets of wallpaper can be properly aligned along seams between adjacent sheets.

There are two commonly used alignment systems with one being a butt alignment wherein the lateral edges of adjacent strips of wallpaper are abutted against each other. The other mounting system is a lap system wherein one sheet of wallpaper material is overlapped along the adjacent edge of an adjacent sheet of wallpaper and the overlap may be subsequently removed by cutting and removing the overlap. In either instance, the patterns on the wallpaper are typically designed to be continuous across an adjoining seam for aesthetic continuity even though the seams themselves remain visible.

Wallpapers are not always simply graphically printed. More recently some wallpapers have included a flexible paper base material on which is applied a foam polymer which defines a build-up or embossing on the paper base material. Of course, the foam polymer material can be applied in various patterns and thicknesses for desired aesthetics and also provides acoustical control but the degree of acoustical control depends to some degree on the aesthetic pattern and therefore the foam polymer does not provide an independent means for desirably controlling the acoustics.

Fabric wallpaper coverings have also become popular primarily for their aesthetics as they provide a warmer and softer appearance than conventional wallpaper coverings. The seams between adjacent sheets of fabric wall coverings have been a problem, however, as they will fray when trimmed unless there is a high polymer content in the fabric, which is not always desirable from an aesthetic standpoint.

A disadvantage in all wallpapering resides in the seams between adjacent sheets of material which have traditionally been visible and, therefore, distracting from an aesthetic standpoint. Further, in the case of fabric wall coverings, as mentioned above, the edges can become frayed when cut unless the fabric is highly impregnated with polymers, which is not always desirable, thus causing the seams to be ragged and thus aesthetically displeasing.

Attempts have been made to cover walls with fabric that is not unrolled onto the wall surface in a conventional manner but rather which is premounted on acoustical or wood panels so the fabric overlies one face of the panel and is adhered along edges of the panel to the reverse face of the panel. The panels are then mounted on a wall with the fabric covering the exposed face of the panel. Such systems do provide a soft warm appearance with acoustical advantages but are very labor intensive to assemble and apply.

Accordingly, a covering for architectural surfaces that can be applied in strips or sheets and having exposed fabric for aesthetics, a built-in system for control of acoustics, and invisible or hidden seams would be desirable. It is to provide such a covering and a method of forming and applying the same that the present invention has been developed.

### SUMMARY OF THE INVENTION

The covering for architectural surfaces of the present invention includes a plurality of strips or elongated sheets of material that are positioned in side-by-side relationship on the architectural surface in a manner to hide the seams between adjacent strips, provide control over acoustics, and present a soft and warm appearance through the use of fabric materials.

The strips of material used in the covering in one embodiment have a flexible base material which could be fabric, paper or other suitable material and a top overlay or facing layer of a fabric material or the like secured to the base material. The overlay has at least one fold therein to define a cell between the overlay and the base material. A fold preferably extends along at least one lateral edge of the strip so as to be adapted to abut against an adjacent fold in an adjacent strip mounted on the architectural surface such that the seam between the adjacent lateral edges of the base material may be hidden behind the folds in the overlay material and therefore invisible from view.

The overlay material can be one of numerous material providing desired aesthetic and acoustical properties such as woven or nonwoven fabrics or the like. The overlay material is extended along the length of the base material with fold lines extending in a lengthwise direction and as mentioned previously in one embodiment, with at least one fold along one lateral edge of the base material. The opposite edge of the overlay material might also be folded such that the folds are positioned above the edges or seams of the base material and hide the seams therebeneath. The overlay material can be secured to the base material in any suitable manner such as with adhesive, ultrasonic bonding, welding, or the like.

There can be one or more strips of overlay material applied to one strip of base material depending upon desired aesthetics and where there is more than one strip of overlay material applied to a base material, the folds along adjacent edges of the strips of overlay material are positioned in abutting relationship to conceal the underlying base material from view.

In alternative embodiments, the folds along adjacent overlay materials may not be abutting but might be spaced a predetermined amount to expose a reveal strip of material which bridges the space between adjacent edges of the strips of overlay materials and overlies the base material. The reveal strips of material might be the same or a different fabric material from that of the overlay material or might be metal, wood, or the like depending upon desired aesthetics. The fold or folds in the overlay material are preferably positioned to conceal any underlying edges of the reveal or overlay materials.

As mentioned, the overlay material can be one strip of material or a plurality of strips of material but in either case defines cells between the overlay material and the base material. When using one strip of overlay material, it might have multiple folds defining cells between fold lines. Further, the cells whether they be in the overlay material or in a reveal material can be filled with various padding materials such as paperboard, fiberfill, foam, or the like to control the aesthetics of the visible surface of the covering and acoustics.

In other embodiments of the invention, the base material is a fabric or fabric-like material and is folded upon itself to define one or more fold lines along its length. Cells are then defined between the fabric base material and the underlying architectural surface. These cells may also be filled with a padding or spacer material if desired.

In still other embodiments, the covering material of the present invention includes an elongated strip of base material which may be, by way of example, a woven or non-woven fabric and a padding material laminated to one surface of the base material in a manner such that longitudinal edges of the base material can be folded around corresponding edges of the padding material and secured thereto to form an elongated padding filled cellular strip of covering material that can be mounted directly on an architectural surface. The product is designed so that it can be stored in a rolled condition prior to folding the edges of the base material around the corresponding edges of the padding material with the folding step being performable onsite.

The folded edges of the base fabric material are secured to the padding material with a hook-type material of the type sold under the trademark Velcro® and the completed padding-filled cellular laminate material can be mounted on the architectural surface, also with Velcro®-type fastenings. The strips of covering material can be mounted on the architectural surface in contiguous relationship so as to hide the seams therebetween or could be mounted in a spaced relationship so as to define relief areas where other fabric, cellular material or strips of decorative material, such a wood or aluminum, can be mounted again in a manner to conceal seams as is well described in the aforenoted copending provisional application filed on even date herewith.

The present invention is also directed to a method for forming a padded material for covering architectural surfaces as well as a method of applying the product to an architectural surface so that the entire architectural surface can be covered in an aesthetically-pleasing manner.

Other aspects, features and details of the present invention can be more completely understood by reference to the following detailed description of preferred embodiments, taken in conjunction with the drawings and from the appended claims.

### BRIEF DESCRIPTION OF THE DRAWINGS

FIG. 1 is a fragmentary isometric of a first embodiment of the present invention showing a plurality of overlay strips on a base material to define a plurality of cells between the overlay and the base material.

FIG. 2 is a section taken along line 2-2 of FIG. 1.

FIG. 3 is an enlarged fragmentary section taken along line 3-3 of FIG. 2.

FIG. 4 is a fragmentary section taken along line 4-4 of FIG. 3.

FIG. 4a is a fragmentary isometric of a second embodiment of the present invention showing a plurality of overlay strips mounted on a base material and with reveal strips positioned between the overlay strips.

FIG. 4b is an enlarged section taken along line 4b-4b of FIG. 4a and with a fragmentary representation of an adjacent strip of base and reveal material positioned to be adjoined to a primary strip of base material.

FIG. 5 is a fragmentary section similar to FIG. 1 wherein the overlay material defines cells of a larger dimension than that of FIG. 1.

FIG. 6 is an end elevation of the embodiment shown in FIG. 5.

FIG. 7 is a fragmentary isometric similar to FIG. 1 showing an embodiment of the invention wherein a single strip of overlay material defines a single cell on a base material.

FIG. 8 is an end elevation of the embodiment shown in FIG. 7.

FIG. 9 is a fragmentary isometric illustrating a plurality of strips of base material in accordance with the embodiment of FIG. 1 with the base materials overlapped and mounted on an architectural surface.

FIG. 10 is an enlarged fragmentary section taken along line 10-10 of FIG. 9.

FIG. 11 is a fragmentary isometric of another embodiment of the present invention wherein one overlay strip is mounted on a base material adjacent to a reveal strip and wherein both the overlay material and the reveal strip define a cell between the strips and the base material.

FIG. 12 is an end elevation of the embodiment shown in FIG. 11.

FIG. 13 is an end elevation of another embodiment of the present invention wherein strips of fabric material are folded and applied to an architectural surface in overlapped relationship.

FIG. 14 is a fragmentary isometric of the embodiment shown in FIG. 13.

FIG. 15 is an end elevation of a variation to the embodiment shown in FIG. 13 wherein the strips of material are folded along opposite edges.

FIG. 16 is an end elevation of still another arrangement similar to FIG. 13 showing a different folding pattern of individual strips of fabric material.

FIG. 17 is an end elevation of a plurality of overlapping strips of material that have been individually folded by folding the material back upon itself at a plurality of locations.

FIG. 18 is an end elevation of a variation to the embodiment shown in FIG. 17 wherein the individual strips of material are again folded back upon themselves in a different pattern.

FIG. 19 is a fragmentary end elevation of two adjacent strips of material for application to an architectural surface wherein each strip has a base material and a plurality of spaced overlay strips that have been folded under along opposite edges and secured to the base strip.

FIG. 20 is a transverse section of two strips of material that can be bonded together on an architectural surface and wherein each strip of material is folded in a predetermined pattern to define a cell along the underside thereof which receives a spacer strip to hold the strip in an elevated relationship relative to the architectural surface upon which it is mounted.

FIG. 21 is a fragmentary transverse section showing still another embodiment of the present invention mounted on an architectural surface and wherein the embodiment encompasses strips of base material having an overlay wherein the edges of the overlay are bonded to the base material so as to define a raised intermediate area and a cell between the raised intermediate area and the base material and wherein adjacent edges of the base materials are covered with reveal strips which have been filled with a padding material.

FIG. 21a is a fragmentary exploded transverse section of an embodiment similar to that shown in FIG. 21 wherein the space between the intermediate portions of the overlay material and the base material are filled with a padding.

FIG. 22 is a transverse section through an edge trim piece adapted to be secured along exposed ends of strips of covering in accordance with the present invention.

FIG. 23 is an exploded fragmentary isometric showing the edge trim piece of FIG. 22 in position to be applied to the end of a covering in accordance with the present invention.

FIG. 24 is a fragmentary isometric similar to FIG. 23 but wherein the components are not exploded but not yet secured together.

FIG. 25 is a fragmentary isometric similar to FIG. 24 with the components secured together.

FIG. 26 is an isometric view of two perpendicular architectural surfaces having a medley of coverings in accordance with the present invention mounted thereon.

FIG. 27 is an exploded fragmentary isometric of still another embodiment showing a base sheet material and secondary padding material.

FIG. 28 is a fragmentary isometric showing a laminate of the base sheet material and padding material of FIG. 27 in interconnected relationship.

FIG. 29 is a fragmentary isometric showing the laminate of FIG. 28 in a heat press for compressing longitudinal edges of the laminate.

FIG. 30 is a fragmentary isometric similar to FIG. 29 with the press in engagement with the laminate.

FIG. 31 is a fragmentary isometric showing the laminate of FIG. 28 subsequent to the pressing of its longitudinal edges.

FIG. 32 is a fragmentary partially exploded isometric showing strips of a hook and loop fastener prior to being applied to the top and bottom surfaces of the pressed longitudinal edge of the laminate as seen in FIG. 31.

FIG. 33 is a fragmentary isometric similar to FIG. 32 with the hook and loop fastener material adhered to the laminate along the compressed edges.

FIG. 34 is a fragmentary isometric similar to FIG. 33 with the compressed longitudinal edges of the laminate being folded upon the padding material.

FIG. 35 is a fragmentary isometric similar to FIG. 34 which has been inverted and wherein the longitudinal edges of the laminate are folded and secured to the padding material.

FIG. 36 is a fragmentary isometric showing a plurality of strips of material as seen in FIG. 35 in contiguous relationship as they would appear on an architectural surface.

FIG. 37 is an enlarged fragmentary section taken along line 37-37 of FIG. 36.

FIG. 38 is a fragmentary section illustrating one longitudinal edge of a strip of covering material as shown in FIG. 35 which has been secured to an architectural surface with a hook and loop type material.

FIG. 39 is a fragmentary isometric showing an interior of a room in an architectural structure which has been prepared for receiving covering material of the type shown in FIGS. 37 and 38.

FIG. 40 is an enlarged fragmentary section taken along line 40-40 of FIG. 39.

FIG. 41 is a fragmentary isometric similar to FIG. 39 with the walls of the architectural structure having been covered with strips of covering material in accordance with the present invention.

FIG. 42 is a fragmentary isometric showing a portable press used for compressing an end edge of a strip of covering material as shown in FIG. 35 in accordance with the present invention.

FIG. 43 is a fragmentary isometric similar to FIG. 42 wherein the press is in engagement with the laminate material for compressing the end edge of the material.

FIG. 44 is a fragmentary isometric showing the end of a strip of covering material in accordance with the present invention wherein the end edge has been compressed as shown in FIGS. 42 and 43.

FIG. 45 is a fragmentary isometric similar to FIG. 44 wherein corners of the strip of covering material have been severed to prepare the compressed edges of the material for folding.

FIG. 46 is a fragmentary isometric similar to FIG. 45 wherein hook and loop type fastener material has been applied to the top surface of the compressed end of the covering material and a strip of hook and loop material is positioned for application to the lower surface of the compressed edge.

FIG. 47 is a fragmentary isometric similar to FIG. 46 wherein the compressed edges of the strip of covering material have been folded onto the adjacent padding material.

FIG. 48 is an enlarged fragmentary section taken along line 4848 of FIG. 47.

FIG. 49 is a fragmentary isometric showing a pair of strips of covering material as shown in FIG. 33 having been mounted on an architectural surface with a strip of flat relief material therebetween.

FIG. 50 is a fragmentary isometric similar to FIG. 49 with a padded relief strip replacing the flat strip of FIG. 49.

FIG. 51 is a fragmentary isometric illustrating another embodiment of the present invention where the longitudinal side edges of the base material are not folded upon the padding material but rather form a lateral extension therefrom and wherein a stuffed strip of material is mounted along adjacent lateral edges of the covering material.

FIG. 52 is a fragmentary isometric of still another embodiment of the present invention wherein one side edge of a covering material is folded upon and connected to the padding material while the opposite edge of the base material forms a lateral extension and wherein the folded edge of one strip of covering material overlies the laterally extending edge of an adjacent strip so as to conceal the seam therebetween.

### DETAILED DESCRIPTION OF THE INVENTION

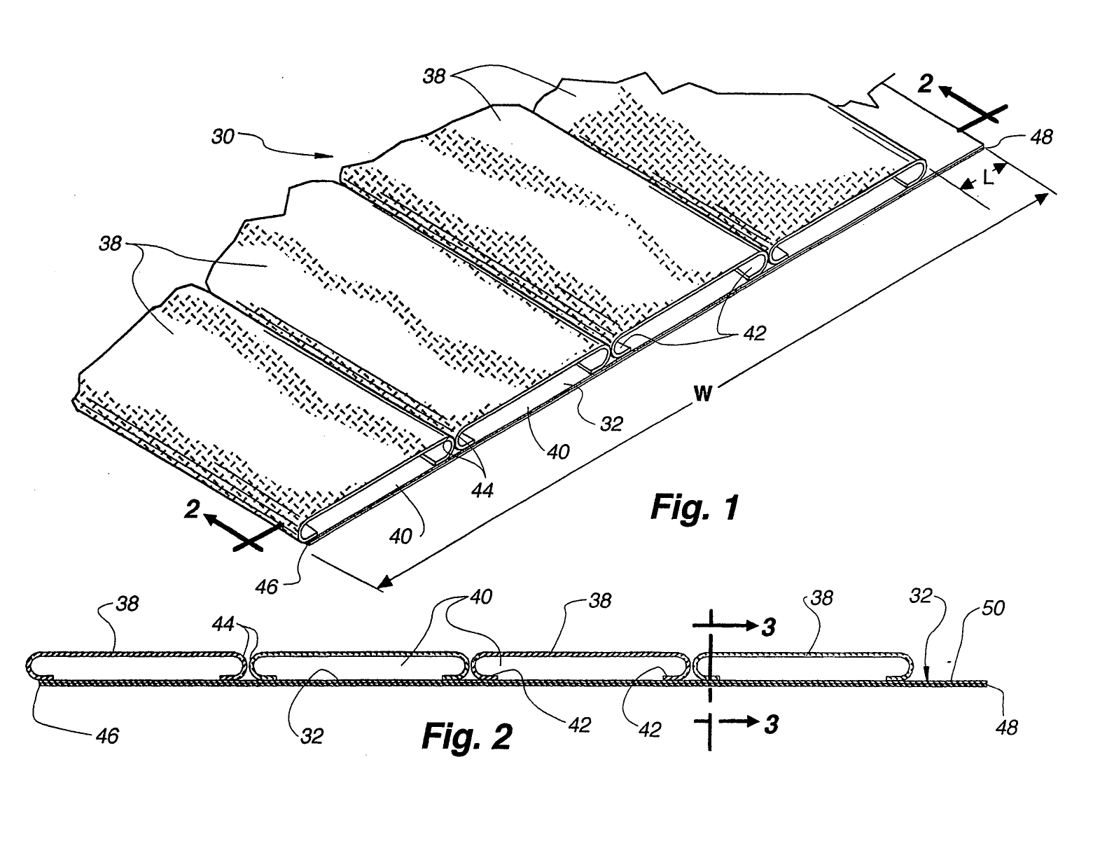

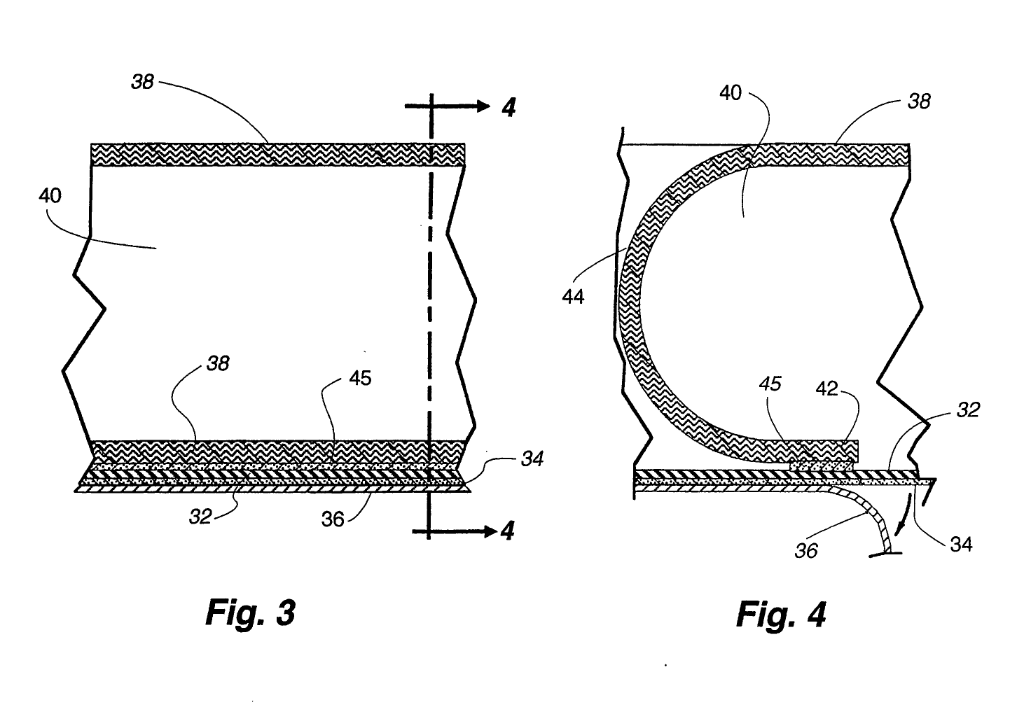

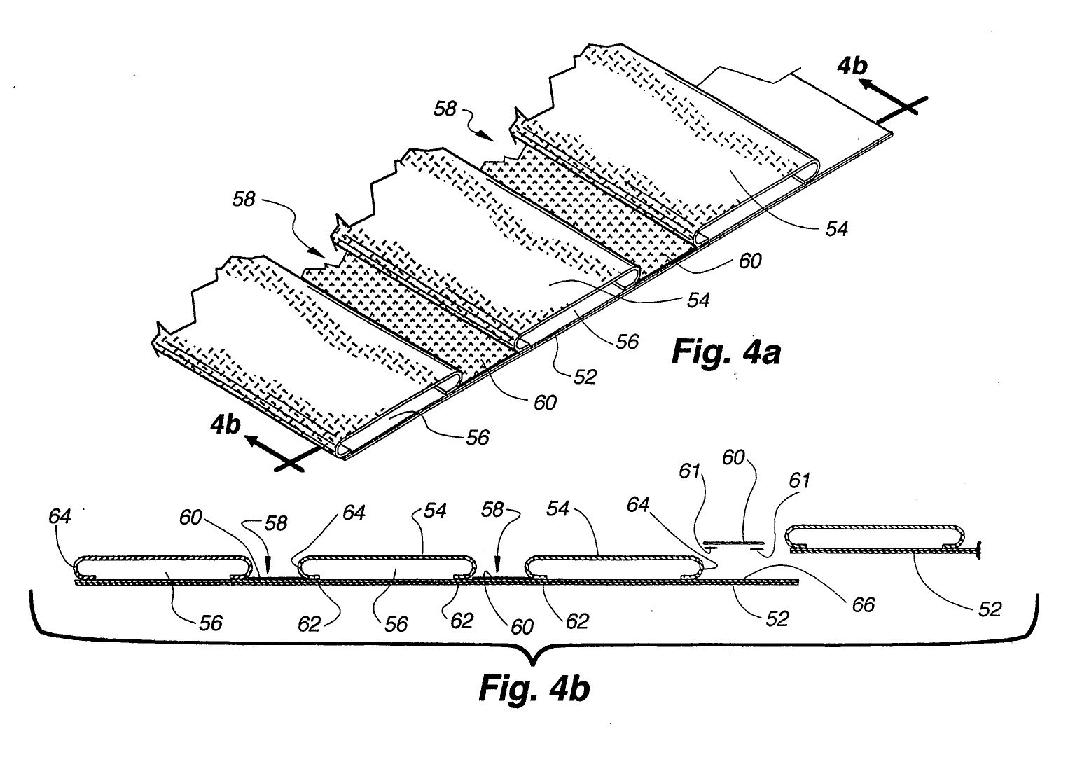

A first embodiment 30 of the covering of the present invention can be seen in FIGS. 1-4 to comprise an elongated base sheet or strip of material 32, having a width W, with the strip being adapted to be secured to an architectural surface (not shown) in any suitable manner. The length of the material would depend on the height of the surface on which it is to be mounted if mounted vertically, or the width of the surface if mounted horizontally. The underface of the base material 32 could have a preapplied adhesive that is activated with water, could be an adhesive with a tear-away paper covering or could have no adhesive but be adapted to be secured to an architectural surface with an adhesive that has been preapplied to the architectural surface in a manner to receive the covering of the present invention. In the embodiment of the invention illustrated in FIGS. 1-4, a tacky adhesive 34 is applied to the base sheet material on its undersurface and covered with a tear-away sheet of paper 36 as illustrated best in FIGS. 3 and 4. The base sheet material itself can be any suitable material such as a fabric or paper material which is flexible to facilitate its mounting and adhesion to the architectural surface. If a paper material is used, it is preferable that it be somewhat stretchable such as a crepe paper. It is evident the architectural surface on which the covering of the present invention is adapted to be applied could be a wall, ceiling, door, or any other surface found in building structures where coverings for aesthetic, acoustic or other purposes might be desirable.

The top surface of the base sheet material supports a plurality of strips 38 of overlay or facing material that are preferably a woven or non-woven fabric or similar material. The overlay material is flexible and mountable on the top surface of the base sheet material so as to define cells 40 between the overlay material and the base sheet material.

Each strip 38 of overlay material is mounted on the base sheet material 32 in adjacent abutting side-by-side relationship with the strips of overlay material extending lengthwise of the base sheet material. Each strip of overlay material has its lateral side edges 42 turned under and inwardly toward each other so as to define an outwardly curved fold 44 along each edge of the overlay material. The inturned edges of the overlay material are adhesively or otherwise secured to the top surface of the base sheet material so that the cells 40 defined between the overlay material and the base sheet material are substantially ovular in configuration.

In the embodiment shown in FIGS. 1-4, there are four side-by-side overlay strips 38 of material defining four cells 40 that are elongated and tubular so as to extend along the length of the base sheet material. One fold 44 in one of the strips of overlay material overlies one lateral edge 46 of the base sheet material 32 for a purpose to be described later while the overlay strip of material at the opposite side of the base sheet material is spaced from the lateral edge 48 of the base sheet material. This spacing defines an exposed zone 50 of material having a width L that is adapted to receive an adjacent strip of base sheet material 32 in an overlapped relationship when mounted on an architectural surface so as to define an overlap seam (not shown) between adjacent strips of covering material in a manner to be described in more detail later. Of course, the lateral edges 46 and 48 of the base sheet material 32 can also be beveled to maintain a constant thickness at the overlap which is well known in the art. It should be understood, however, that the exposed zone 50 of material need not be provided but rather the associated lateral edge 48 of the base sheet material could be positioned beneath the fold 44 of the overlay material along that edge identically to the opposite lateral edge of the base sheet material. In this circumstance, a butt seam (not shown) could be used between adjacent strips of covering material rather than an overlap seam as is also common practice in the wall covering industry.

The overlay material could be any suitable and desired material which would provide predetermined aesthetic and/or acoustical properties to the covering. By way of a preferred example, woven or nonwoven fabrics, natural or synthetic, have been found suitable for this purpose even though other materials having different aesthetics or acoustical properties might also be used. The covering could be provided in roll or slab form depending on the desired method of application which would be true of any of the disclosed embodiments of the invention that follow.

FIGS. 4a and 4b illustrate an alternative to the embodiment of FIGS. 1-4 wherein again a base sheet material 52 is provided with strips 54 of overlay materials secured to the upper surface thereof by adhesive or other suitable means to define elongated substantially ovularly shaped cells 56 between the overlay material and the base sheet material. In the embodiment of FIGS. 4a and 4b, however, the strips 54 of overlay material are spaced from each other defining reveal spaces or areas 58 therebetween of a predetermined consistent, even though they could be inconsistent, spacing and wherein strips of reveal material 60 have been secured to the top surface of the base sheet material in the reveal spaces. The strips of reveal material might be any material desired for aesthetic or acoustical purposes. In the disclosed embodiment, the strips of reveal material 60 are flat sheets of fabric but wood, metal, plastic or such materials might also be used. The lateral edges 62 of the reveal strips are positioned beneath the adjacent folds 64 of the strips of overlay material so as to be concealed or hidden from view. The base sheet material 52 again has an exposed lateral zone 66 to receive in overlapped relationship, as illustrated in FIG. 4b, an adjacent base sheet of material, and as will be appreciated the seam between adjacent base sheets of material will be concealed beneath the folds 64 of the strips of overlay material so as to be hidden from view.

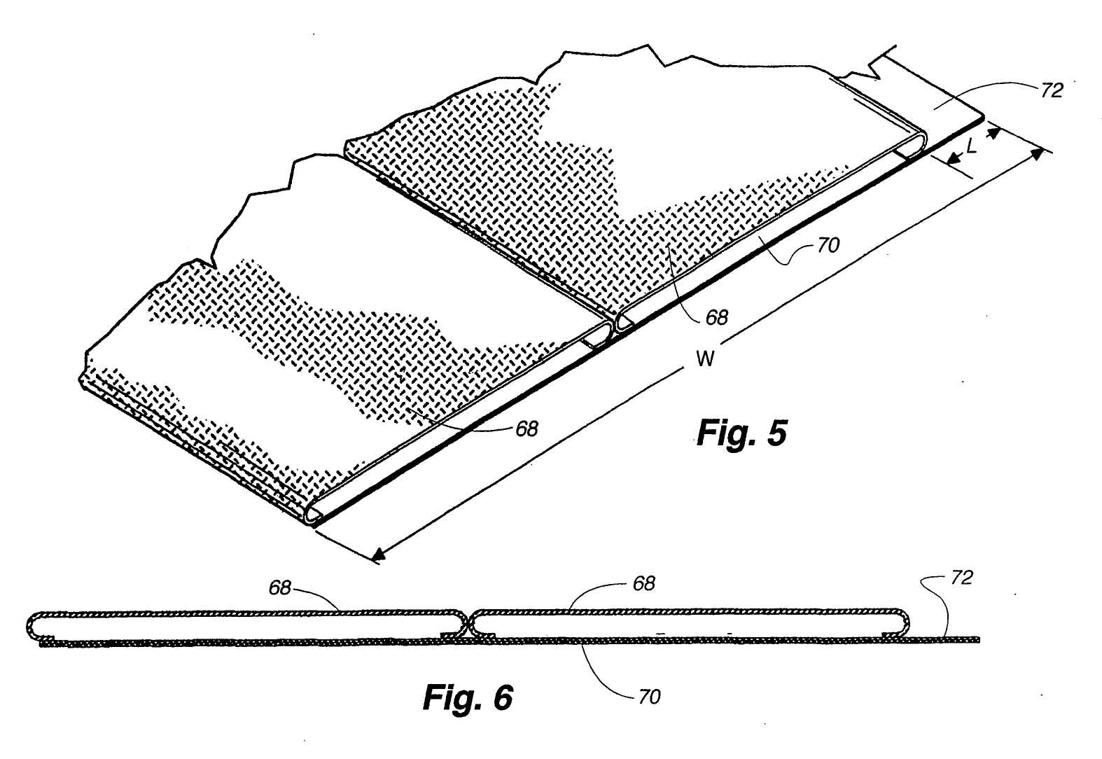

Another alternative to the embodiment shown in FIGS. 1-4 is illustrated in FIGS. 5 and 6 with this embodiment being identical to that of FIGS. 1-4 except the strips 68 of overlay material are wider so only two such strips are secured to a single base sheet 70 material rather than the four disclosed in FIGS. 1-4. Again, an exposed lateral zone 72 is provided on the base sheet material to receive an adjacent base sheet material 70 if an overlapped seam is desired.

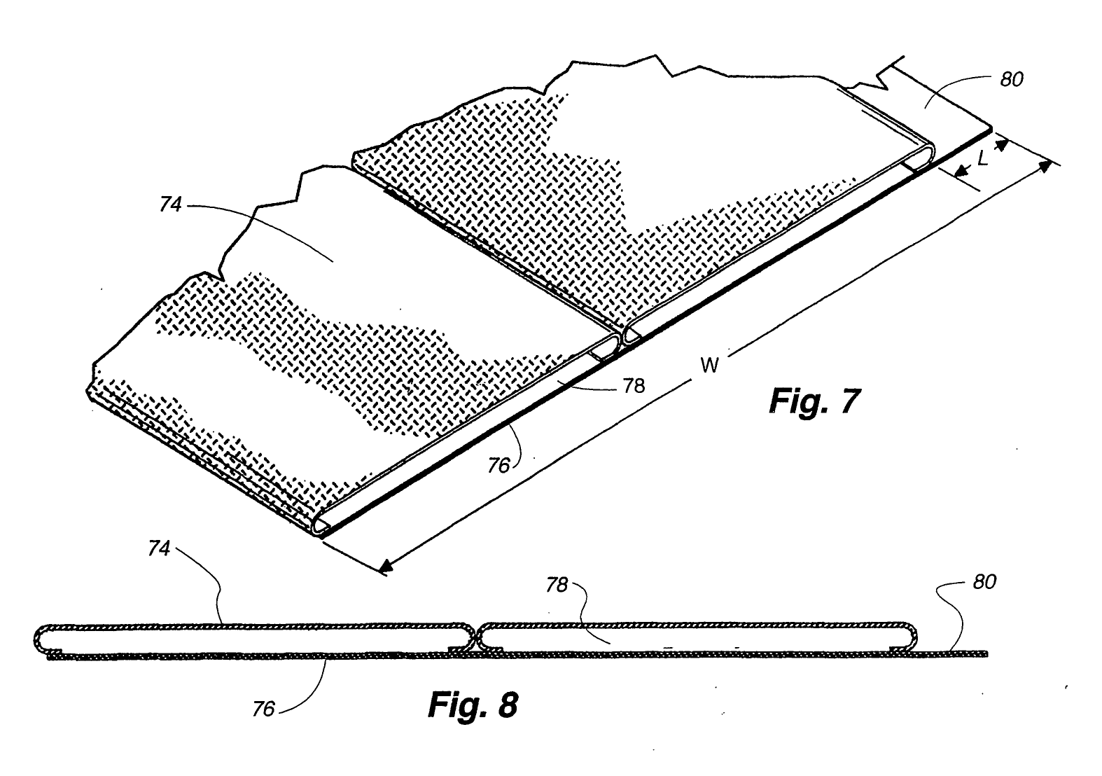

Still another alternative to the embodiment of FIGS. 1-4 is shown in FIGS. 7 and 8 wherein only a single strip 74 of overlay material is provided on a base sheet material 76 again defining a cell 78 between the overlay material and the base sheet material. A lateral exposed zone 80 is provided on the base sheet material to receive in overlying relationship an adjacent base sheet material if an overlap seam between the base sheet materials are desired.

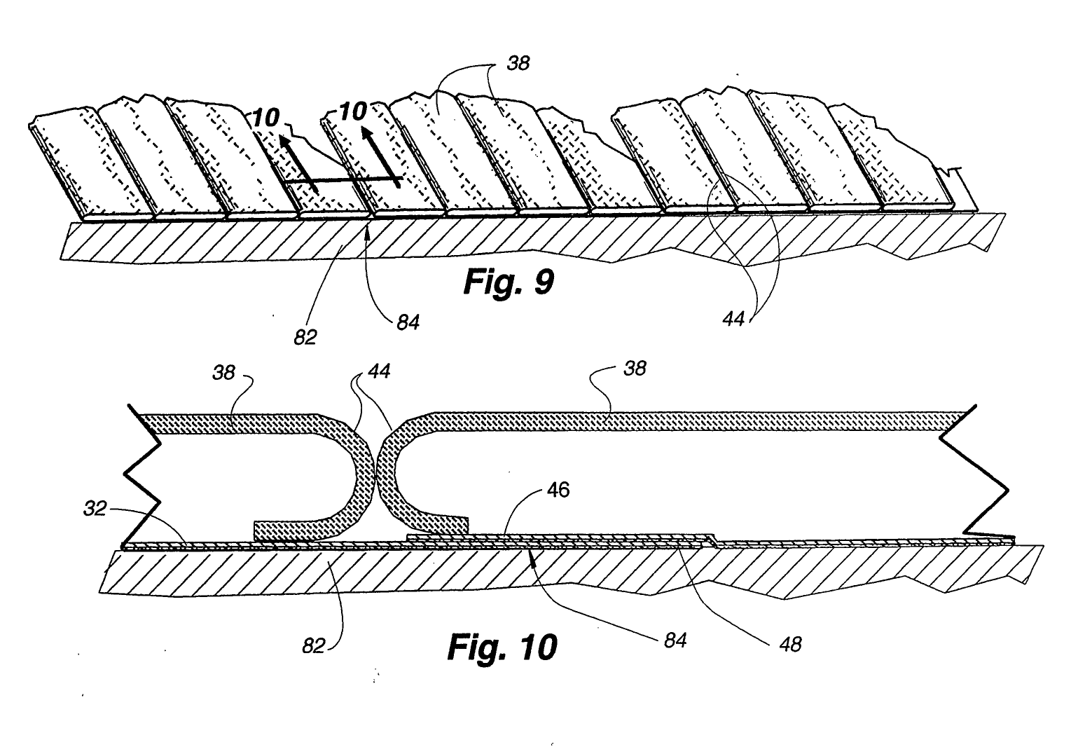

FIGS. 9 and 10 illustrate the embodiment of FIGS. 1-4 mounted on an architectural surface 82 and showing three strips of base sheet material 32 mounted on the surface 82 in adjacent side-by-side relationship. As will be appreciated, the overlap seams 84 between adjacent base sheet materials are hidden from view by the abutting folds 44 of strips of overlay material along opposite edges of the adjacent base sheets of materials. The overlap seam 84 is illustrated best in FIG. 10 wherein it will be seen that the lateral edge 46 of one base sheet material is overlaid onto the opposite edge 48 of an adjacent base sheet material such that the folds 44 of opposing overlay materials are abutted to conceal the overlap seam 84 therebeneath. Of course, the overlap of the base sheet materials are secured together with adhesive or by any other suitable means to hold the base sheet materials in desired position upon the architectural surface.

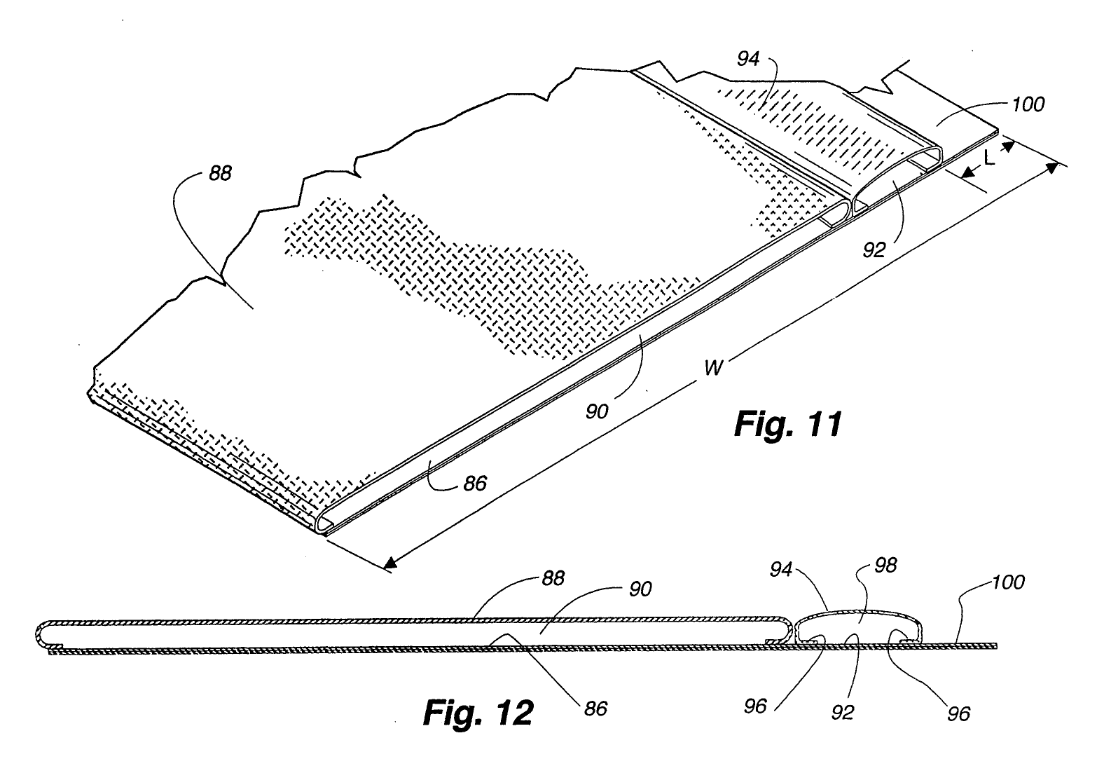

FIGS. 11 and 12 illustrate an alternative to the embodiment of the invention shown in FIGS. 4a and 4b wherein a base sheet of material 86 is provided with a single strip 88 of overlay material secured thereto so as to define a cell 90 between the base sheet material and the strip of overlay material and wherein a reveal area 92 is covered with a reveal strip 94 that has been folded with inturned lateral edges 96 of the reveal strip secured to the underlying base sheet material so as to define a cell 98 between the reveal material and the underlying base sheet material that is adjacent to the cell 90 between the overlay material and the base sheet material. An exposed zone 100 is again provided adjacent to the reveal strip 94 to accommodate an overlap seam (not shown) between adjacent base sheets of material. It will be apparent that the reveal material could be identical to the overlay material or distinct and different therefrom depending on desired aesthetics and acoustics for the covering.

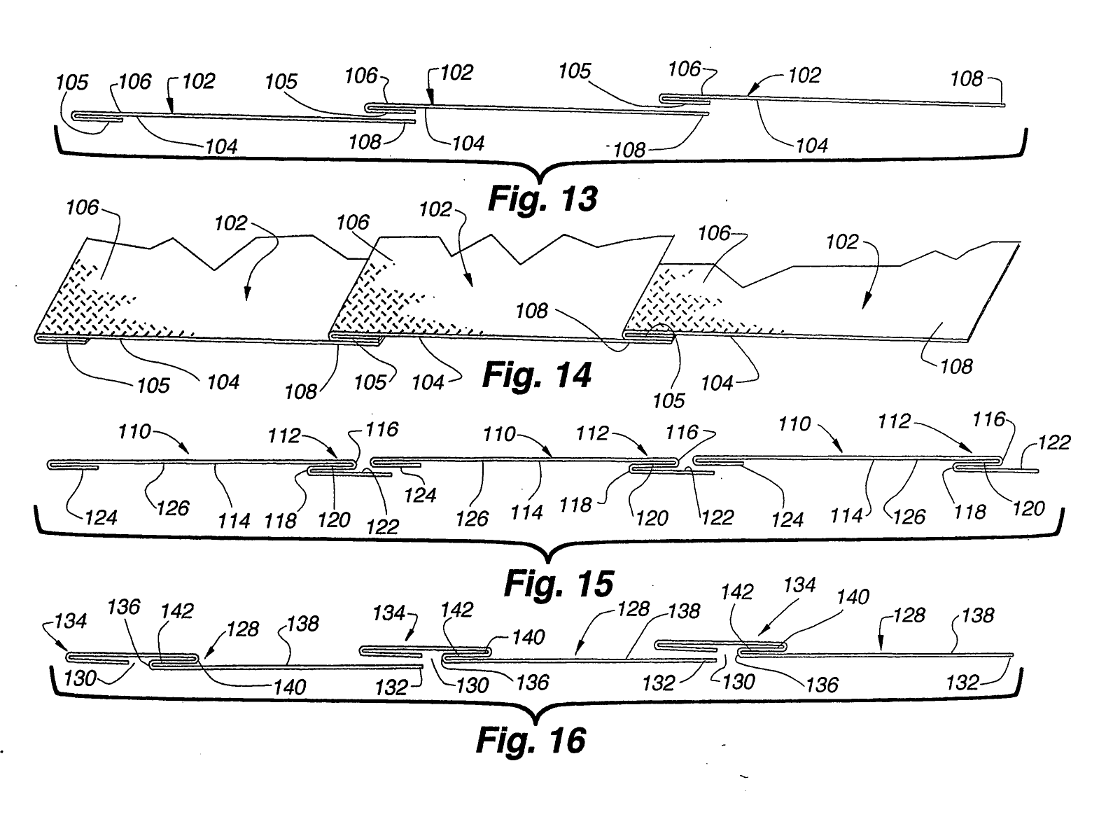

FIGS. 13 and 14 illustrate another embodiment of the present invention wherein the base sheet material 102 itself is a strip of material, preferably fabric material, which has been folded so that a cell 104 is defined between the base sheet material and the architectural surface (not shown) on which the covering is mounted.

Each strip of material 102 is identical and as seen in FIG. 13 is a flexible sheet of material having its left edge 105 folded and turned beneath the remainder 106 of the material. The folded edge may be secured to the material immediately above and is secured to the right free edge 108 of the next adjacent strip of material.

FIG. 15. illustrates an alternative to the arrangement illustrated in FIGS. 13 and 14. Each strip of base sheet material 110 is identical having along the right edge thereof a double fold 112 defining an S-shape in cross section. The main body 114 of the strip of material along the right edge is first folded at 116 in a reverse direction beneath the main body and then again folded at 118 in a reverse direction beneath the first folded area 120 such that the right edge of the strip of material protrudes at 122 beyond the first fold 116 in the strip. The protrusion defines a zone or surface area to which an adjacent strip of material can be secured when applying the covering to an architectural surface. The opposite or left edge 124 of each strip is reverse folded beneath the main body 114 of the strip and may be secured to itself and subsequently is secured to the protruding edge 122 of the next adjacent strip. A cell 126 is defined beneath the main body 114 and the architectural surface on which the base sheet material is mounted.

FIG. 16 illustrates still another arrangement of a base sheet material 128 that is independently folded to define cells 130 between itself and an architectural surface on which it is mounted. The right free edge 132 of the strip is untouched while the left edge 134 of the strip first passes through a double reversing fold which initiates with a reverse fold 136 so as to overlie the main body 138 of the strip and subsequently into a second reverse fold 140 which overlies the first folded area 142 and extends to the left a predetermined distance before the left edge 134 of the strip is reverse folded in a downward direction. The reverse-folded left edge of the strip is then positioned over the right free edge 132 of the next adjacent strip and secured thereto in any suitable manner. Again, the portions of the strip between folds may be secured to themselves to make a cohesive strip of desired configuration.

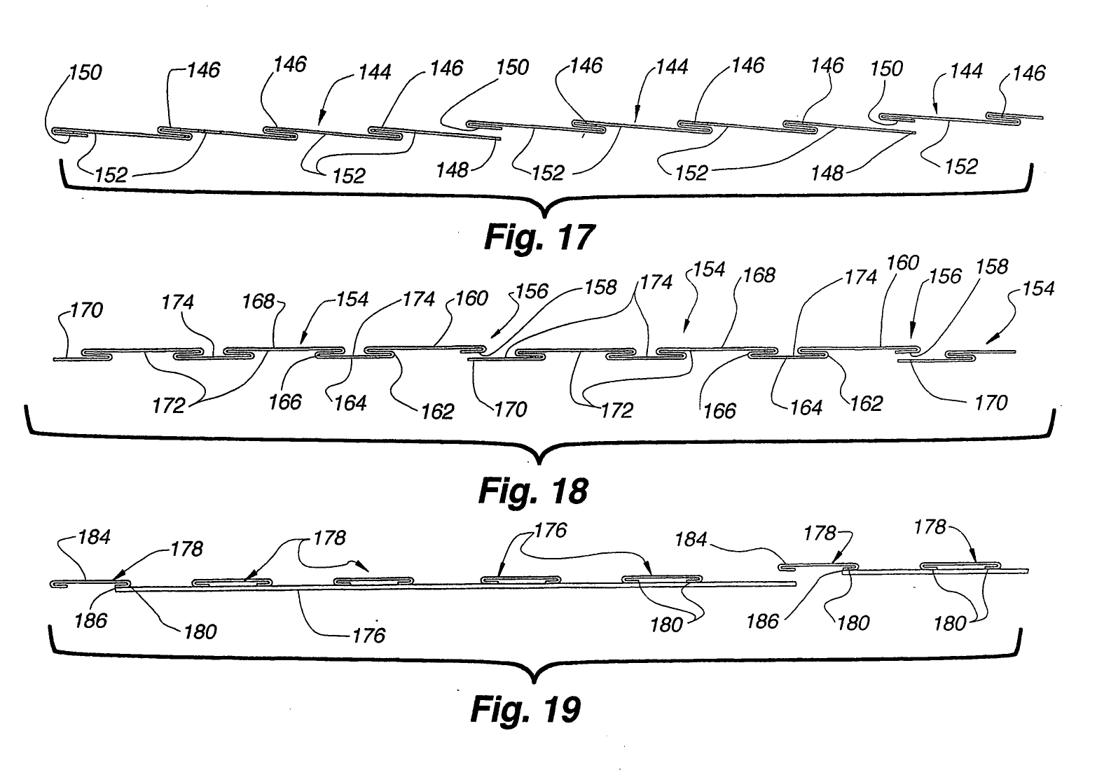

FIG. 17 illustrates still another arrangement of a base sheet material that is independently folded. As will be appreciated, the strip of base sheet material 144 is double-reversed folded at three equally spaced locations 146 from the free right edge 148 of the strip and along the left edge a single reverse downward fold 150 is provided which overlies and is adapted to be secured to a free right edge of the next adjacent strip when mounted on an architectural surface. As with the other arrangements defined above, the folded portions may be secured to themselves and are secured to the adjacent strip, and cells 152 are defined between the base sheet material and the architectural surface (not shown) upon which it is mounted.

FIG. 18 is still another example of a base sheet material 154 that is independently folded. The base sheet material is again in strip form and can be seen to have along its right edge 156 a downward and inward reverse fold 158 and at a predetermined distance to the left thereof at the left edge of a first upper layer 160, a downward double reverse fold 162 is provided defining a lower layer 164 whose left edge is double folded upwardly at 166 to define a second upper layer 168 which is coplanar with the first upper layer 160. The same folding arrangement continues to the left such that three upper layers and three lower layers are defined in each strip and with the single reverse folded right edge 156 of a strip being secured to a free left edge 170 of the next adjacent strip in a suitable manner. The folded portions may also be secured together if desired. As can be appreciated when a base sheet material is formed as illustrated in FIG. 18, downwardly opening cells 172 will be defined between the upper layers and the architectural surface (not shown) on which the base sheet material is mounted and upwardly opening cells 174 will also be defined above each lower layer.

FIG. 19 illustrates a system wherein a base sheet material 176 has a plurality of overlay strips 178 of material secured thereto with the illustrated embodiment showing five such overlay materials associated with each base sheet material. The overlay strips of material have inturned folded edges 180 along both sides which are secured to the base sheet material. The overlay materials are spaced from each other a predetermined distance. The first overlay strip of material is positioned a predetermined distance from the right edge 182 of the base sheet material with that distance being slightly greater than the spacing between overlay strips 178 of material. The overlay strip of material mounted on the base sheet material 176 furtherest to the left is secured to the base sheet material only along the right folded edge of the overlay strip with the remainder 184 of the overlay material protruding away from the left edge 186 of the base sheet material and in a position to be secured to the next adjacent base sheet material along its right edge. Accordingly, when the base sheet materials are mounted on an architectural surface, the protruding portion 184 of the leftmost overlay strip is secured to the right free edge 182 of the next adjacent base sheet material so that seams between base sheet materials are hidden from view by the protruding portion 184.

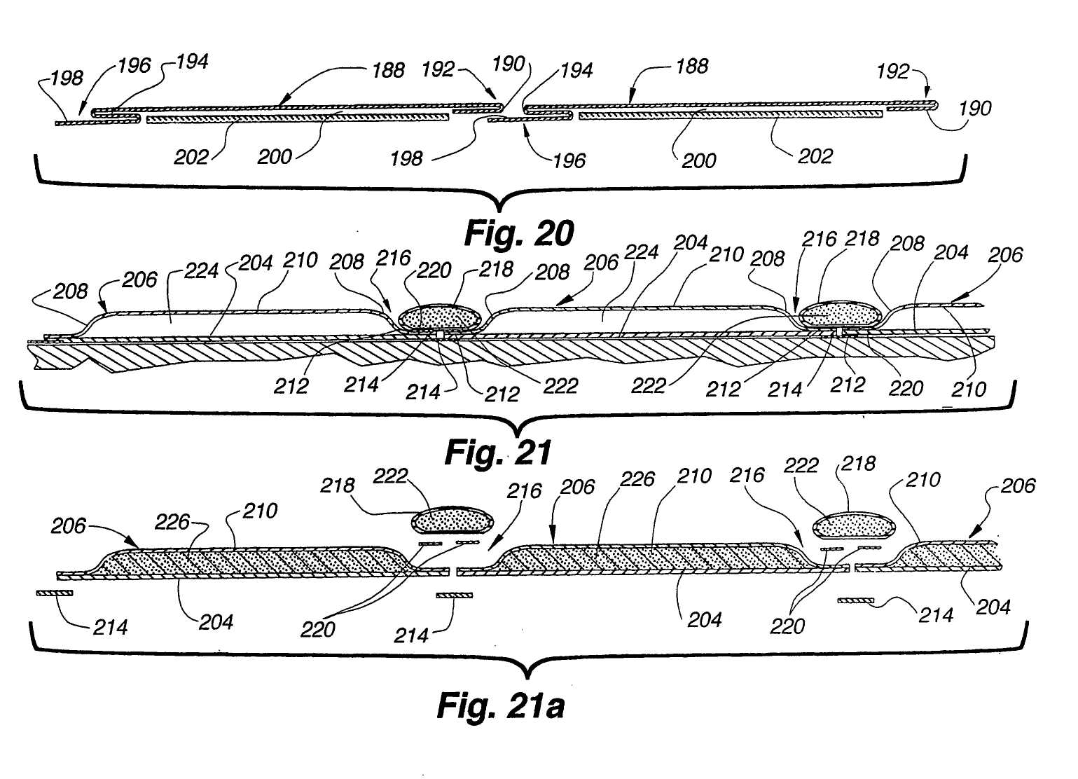

FIG. 20 is an illustration of still another embodiment of the covering of the present invention wherein a base sheet material 188 has a single reverse downward fold 190 along its right edge 192 and a double reversing downward fold 194 along its left edge 196 with the left edge of the base sheet material protruding outwardly and being exposed at 198 for connection to the next adjacent base sheet of material along its single reverse folded right edge 192. As will be appreciated, the base sheet material defines a cell 200 between it and the underlying architectural surface (not shown) on which it is mounted and a spacer or support strip in the form of an insert 202 is positioned in the cell to support the base sheet material in spaced relationship from and in a relatively flat orientation above the architectural surface on which the covering is mounted. The insert or spacer strip 202 could be made of numerous materials including cardboard, paper, fabrics, or the like. The use of such an insert would depend upon the aesthetics desired and also the fabric used for the base sheet material. As will be appreciated, the thickness of the insert could also be varied which would change the aesthetics and acoustics of the covering.

FIG. 21 illustrates a somewhat unusual embodiment of the present invention wherein the base sheet material 204 is again preferably a paper-based or fabric material and has a single overlay sheet 206 associated therewith. The overlay is different from those previously described, however, in that the edges while being folded at 208 are not folded beneath the main body 210 of the overlay material but rather laterally away therefrom. The lateral folded extensions 212 from the main body of the overlay material are secured in any suitable manner to the top surface of the base sheet material 204 along an associated edge thereof. Adjacent base sheet materials are secured together with an underlying strip 214 of adhesive or the like which runs beneath the adjacent edges of adjacent base sheets of material. A trough 216 is defined between adjacent overlay strips 206 that opens upwardly and a reveal strip of material 218 is mounted therein with adhesive strips 220 or the like. In the disclosed embodiment, the reveal material 218 is formed in a substantially ovular transverse cross-sectional configuration and may be stuffed with padding material 222 even though it will be appreciated that as an alternative, flat reveal strips of fabric, metal, wood, plastic, or the like could be secured in the trough. Further, the cells 224 defined between the overlay material and the base material could be left hollow as shown in FIG. 21 or provided with a stuffing 226 as shown in FIG. 21a. The stuffing or padding could be a foam padding or any other material that would desirably fill the hollow spaces.

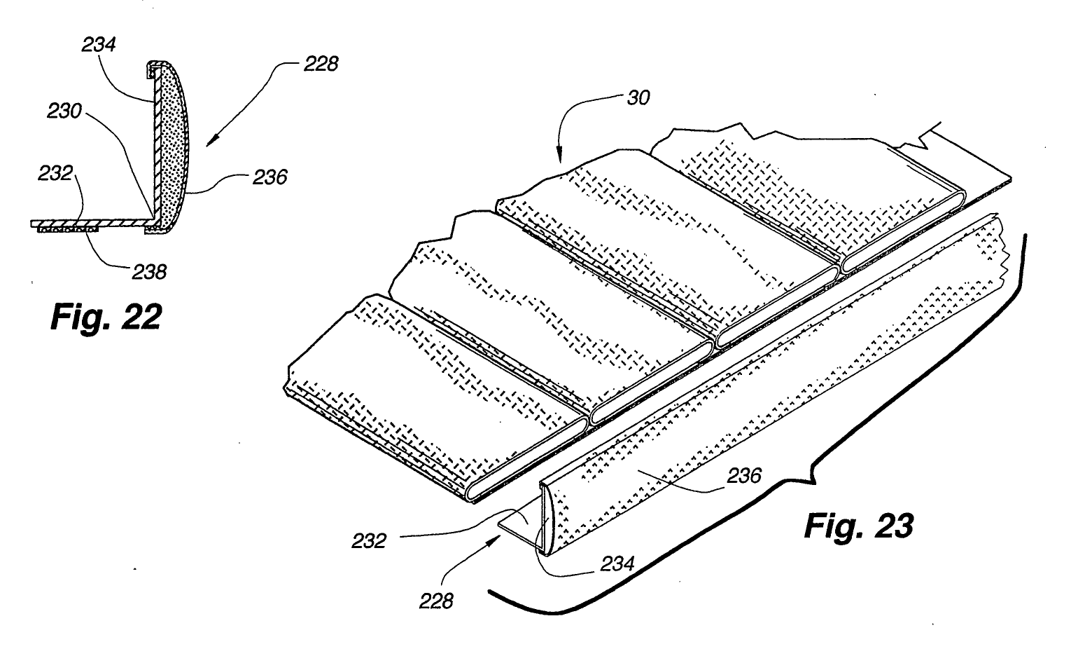

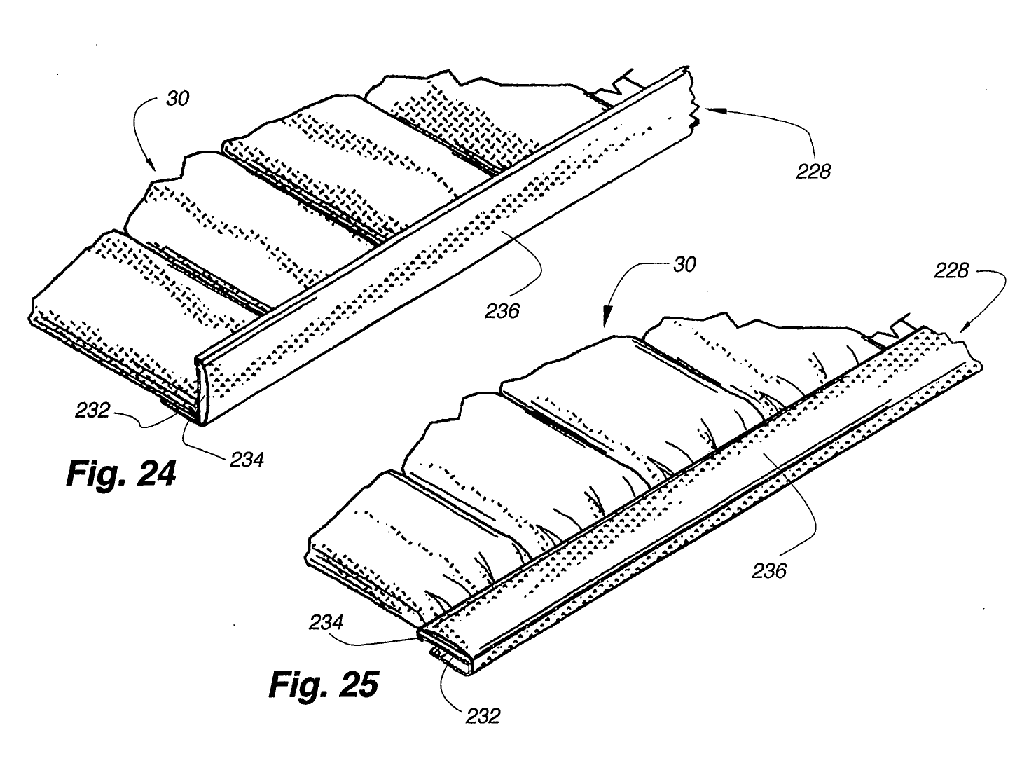

As will be appreciated with any of the afore-noted embodiments, there will be open-ended cells along both ends of the strip of covering material and for aesthetic reasons, it may be desirable to close the cells to provide a finished look. With reference to FIGS. 22-25, an edging trim strip 228 is illustrated that has a bendable metal base 230 of generally L-shaped configuration which defines a lower base leg 232 and an upstanding leg 234. The upstanding leg has a strip of fabric material 236 which might match the fabric material used elsewhere in the covering secured along upper and lower edges thereof so as to define a cell in which a stuffing or padding material 236 might be inserted. The lower or base leg 232 has adhesive 238 along a bottom surface and the lower leg is adapted to be inserted beneath the associated edge of the covering 30 for example as shown in FIG. 24. Of course, the adhesive 238 along the lower base edge is used to secure the base edge to the architectural surface (not shown) on which the covering is mounted. The upstanding leg 234 is subsequently bent so as to be in substantially parallel overlying relationship with the base leg 232 as illustrated in FIG. 25 and in this position overlies the open ends of the cells in the covering to provide a finished appearance.

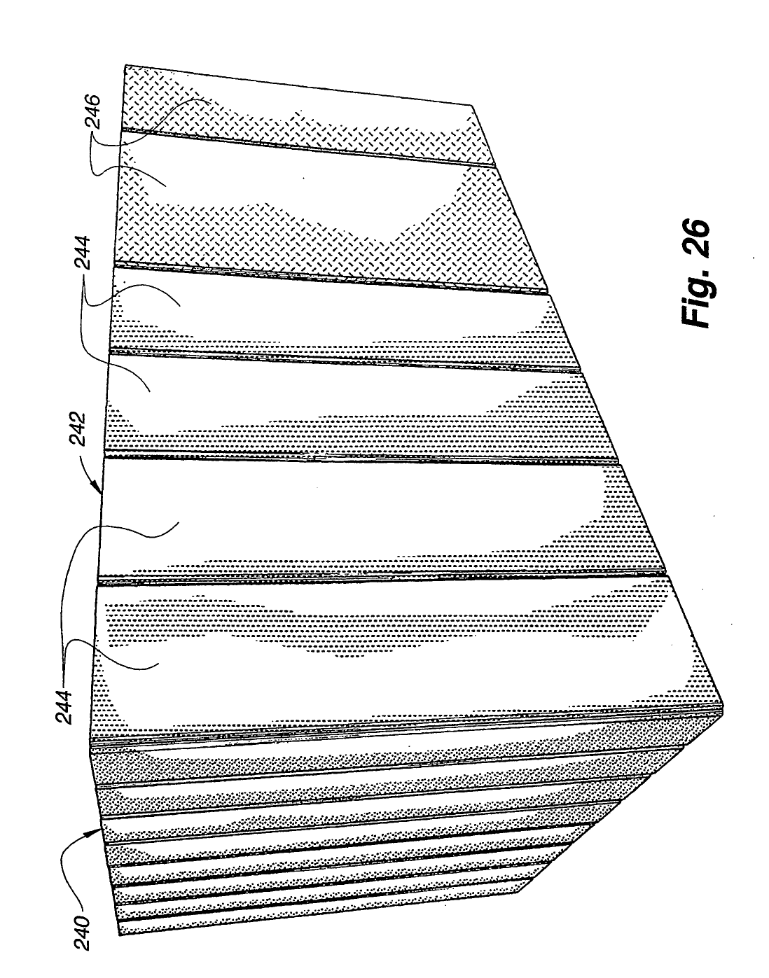

FIG. 26 illustrates a pair of perpendicular architectural surfaces 240 and 242 on which a medley of the coverings described hereinbefore have been mounted. Along the left surface 240, the embodiment illustrated in FIGS. 1-4 has been mounted while across the right surface 242 there is initially mounted at 244 the embodiment illustrated in FIGS. 5 and 6 and next to that at 246 the embodiment illustrated in FIGS. 7 and 8.

In several of the previously described embodiments of the covering of the present invention, cellular structures were formed by folding side edges of a base sheet material upon themselves to define a cell and in some embodiments filling the cell with a stuffing or padding material. It has been discovered that such a structure can be mounted directly upon an architectural surface in a relatively simple manner and so as to conceal or hide the seams between adjacent strips of such material. It has also been discovered that the stuffed base material can be easily formed in a manner such that it can be stored in a rolled form and unrolled at an application site for installation.

It has also been found that the fabrication of the covering material can be enhanced by using a fiberfill material as the padding and particularly a polyester fiberfill material that is soft but has cohesive strength and resilience. An example of a polyester fiberfill material that has been found suitable is manufactured and sold by Union Wadding of Pawtucket, R.I., under the Produce Code 6318883. Such a fiberfill material will adhere readily to conventional hook-type fasteners which form a component of hook-and-loop type fastener materials. Typical of such fastener materials are Velcro® fasteners. In other words, the hook portion of the hook and loop material will grab the fibers in the polyester fiberfill material and remain connected thereto unless excessive force is applied to separate the fiberfill from the hook-type fastener. As will be appreciated from the description that follows, the ability of the fiberfill material to remain connected to hook-type fastener material facilitates the formation of the laminate covering material.

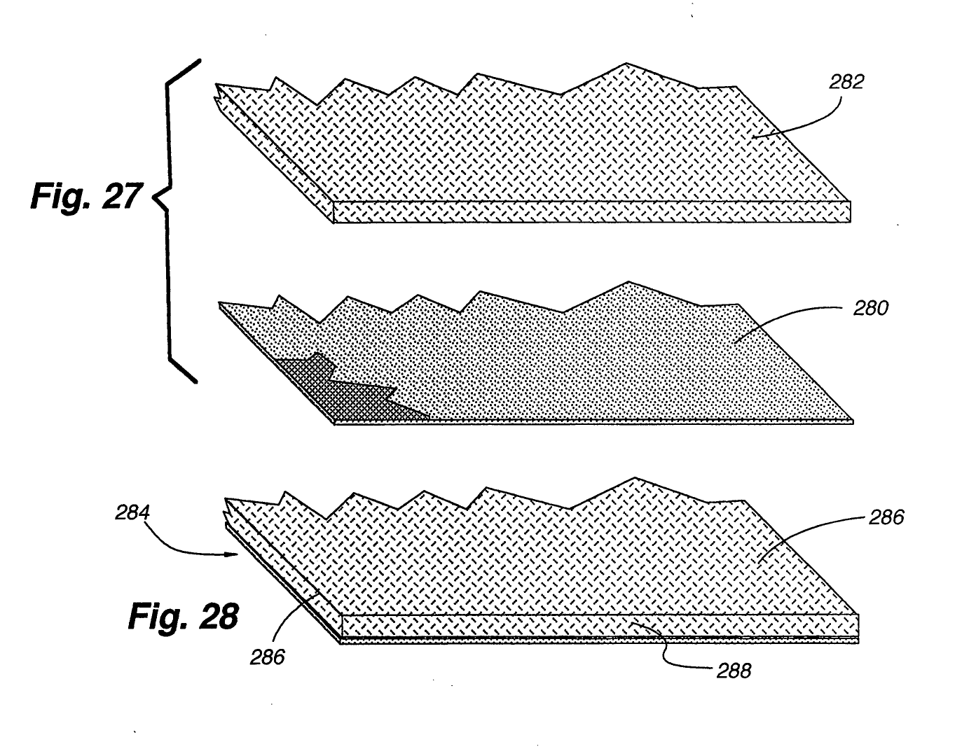

With reference to FIGS. 27 and 28, the basic components of still another embodiment of a covering material of the present invention are a flexible base material 280 and an overlay of a padding material 282 which are secured together into a laminate 284 as shown in FIG. 28. The base material 280 is preferably a flexible sheet-like material, such as a woven or non-woven fabric material, even though other materials having the desired aesthetic and acoustical properties for a wall covering might also be usable. While the padding material 282 could be any suitable material, the above-identified polyester fiberfill has been found to have desirable characteristics.

Both the base material 280 and the padding material 282 are cut in elongated strips of a predetermined width, which in one embodiment of the present invention is identical for both the base layer and the padding layer. The width of the strips is approximately one inch wider than the desired resultant width of the coverage desired on the architectural surface to which the material is to be applied. Any suitable binder can be used for binding the two layers into the laminate shown in FIG. 28.

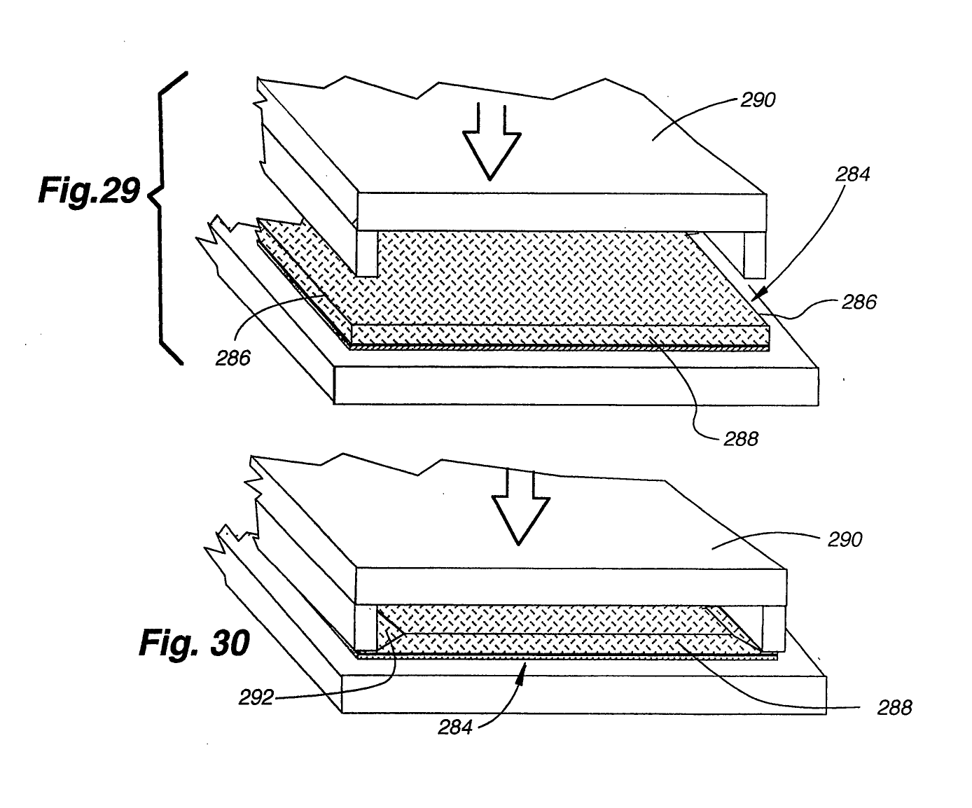

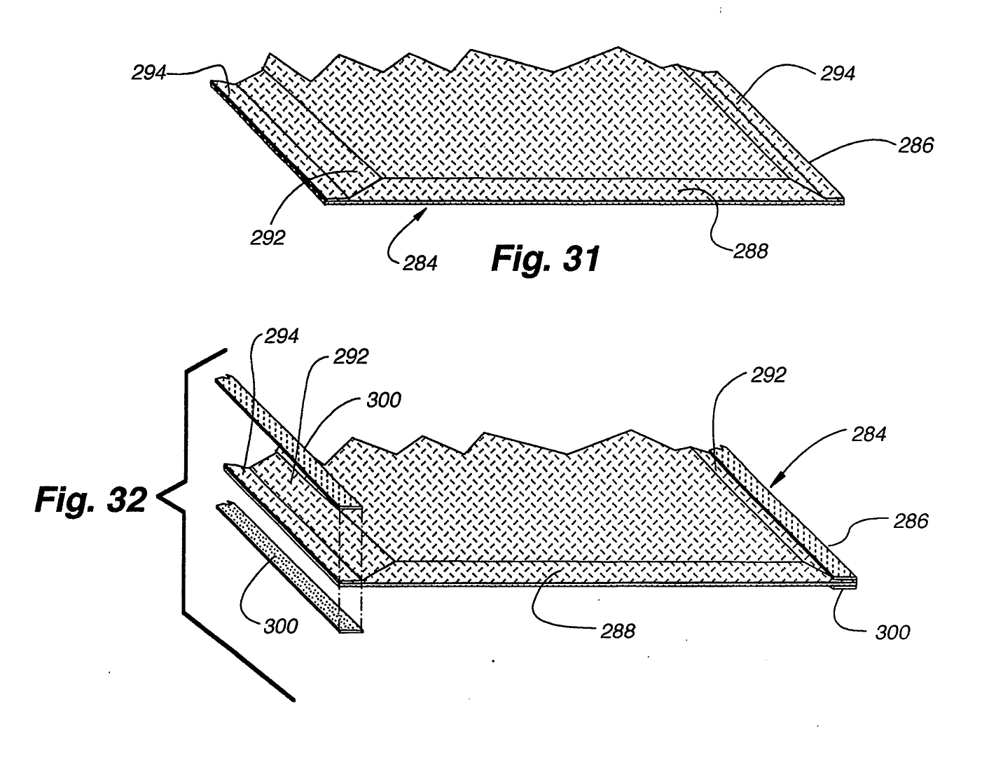

After the laminate 284 has been formed, the elongated strip of laminate material which has longitudinal side edges 286 as well as end edges 288 is processed as shown in FIGS. 29 and 30 to compress the padding material 282 along the longitudinal edges of the laminate into a relatively thin profile. By way of example, the fiberfill might be compressed to approximately 0.020 inches in thickness with the original thickness of the fiberfill preferably being approximately 0.375 inches. The longitudinal side edges 286 of the padding material can be compressed with a heat press 290 so that the fiberfill padding material melts to some degree and remains in a compressed, relatively thin and compact state. There will be some tapering of the padding material at 292 from its uppermost surface to the compressed zone 294, and that is shown in FIG. 31. The tapered surface 292 is desirable for reasons to be described hereafter. If the taper resulting from the compression of the longitudinal edges is not sufficient, a secondary or simultaneous forming of a beveled or tapered surface can be accomplished with a heat press, hot air, or other procedure that would form the desired taper. It should also be pointed out that the laminate could be inverted before compressing so that the heat press 290 engaged the base material 280 rather than the padding material 282. In this instance, a bond would still occur in the padding material, but it would be seen from the base material side of the laminate.

Once the edges 286 have been compressed and beveled surfaces 292 formed, the laminate has the appearance illustrated in FIG. 31 so that the flat longitudinally extending zones or laminated edges 294 are defined on opposite longitudinal edges of the laminate. The top and bottom surfaces of the compressed zones are subsequently treated to define binding or fastening surfaces that can be secured to the padding material 282 as will be described later and to the architectural surface 298 on which the material is ultimately mounted. A material suitable for this purpose is a hook-and-loop type material such as Velcro® and while hook material might advantageously be placed at certain locations and loop material at others, such material is available in a combination form so that hooks and loops are provided along a common surface. For purposes of the present disclosure, it will be assumed a combination hook-and-loop type material is utilized.

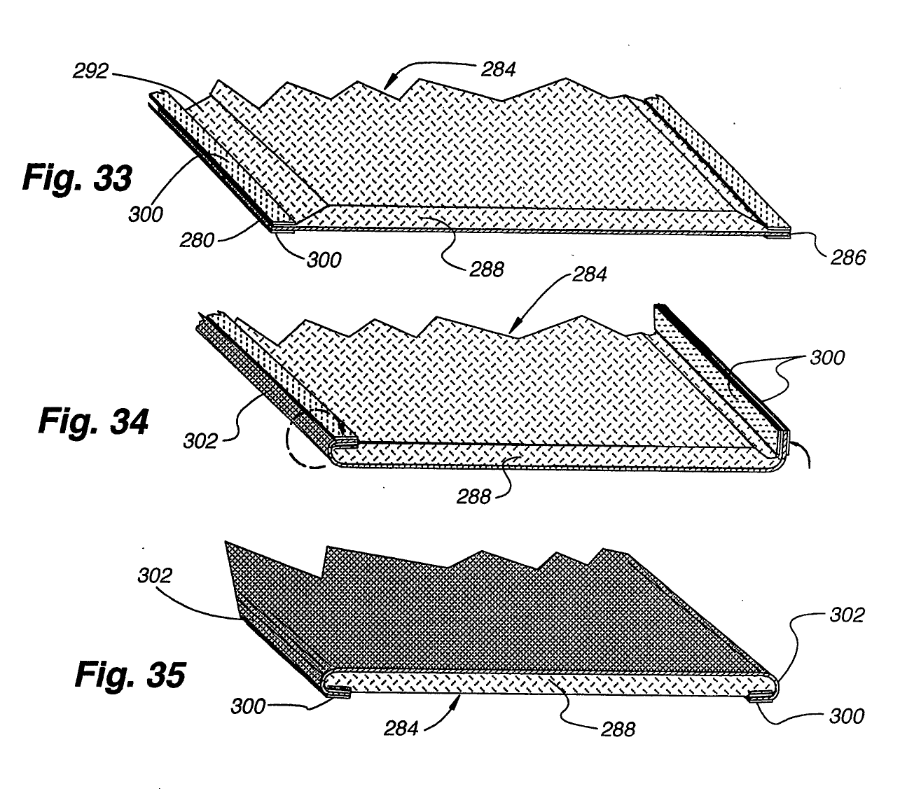

With reference to FIG. 32, each compressed zone 294 has applied to its top and bottom surfaces a hook-and-loop material 300 which can be adhesively bonded to the compressed zone so the hooks and loops on the material extend upwardly and downwardly from the compressed zone. The laminate 284 with the hook-and-loop material applied to the compressed zones is illustrated in FIG. 33 and in this form, the laminate can be rolled along its length to facilitate storage in roll form. It is desirable the material be rolled with the padding material 282 on the outside so the padding material is actually stretched slightly while being rolled and retained in rolled form. Of course, the base material 280 is not stretched as much. When the material is unrolled, the padding material, which has been stretched so as to be slightly longer than its normal size prior to rolling, actually stretches the base material so it has a smooth, flat appearance.

After the laminate material has been unrolled, the compressed longitudinal side edges or zone 294 of the laminate are folded upwardly, as seen in FIG. 34, over the padding material 282 so the hook-and-loop material 300 that was on the top surface of the compressed zones is facing downwardly and binds with the padding material so as to define folded side edges 302 of the covering material which has the base material 280 exposed. The tapered surface 292 facilitates a smooth fold having desired aesthetics. It will also be appreciated that what was the bottom surface of the compressed zones 294 prior to folding becomes the top surface and is exposed in the same direction as the padding material 282, which ultimately confronts and is mounted in face-to-face relationship with the architectural surface 298 as will be described later. After the compressed side edges or zones 294 have been folded as shown in FIG. 34, the covering material can be inverted so the base material 280 lies on the top as seen in FIG. 35 and defines the aesthetic or face material for the covering.

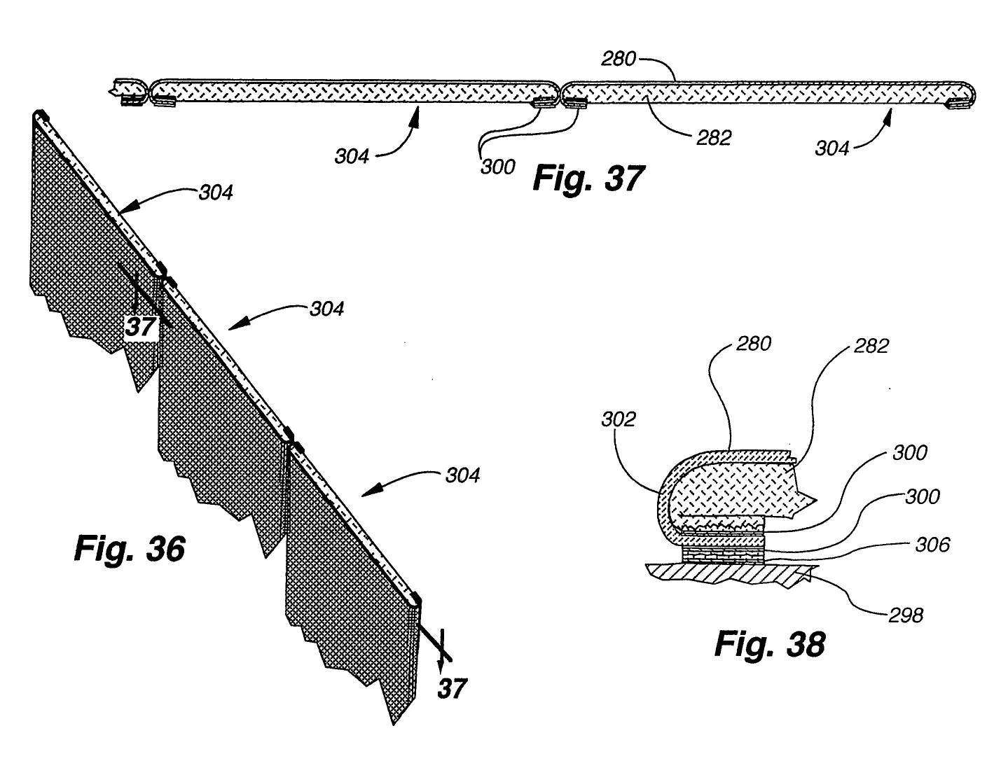

When mounting strips of the covering material 304 as shown in FIG. 35 on the architectural surface 298 such as a wall or the like, a plurality of strips of covering material are positioned in side-by-side relationship as shown in FIGS. 36 and 37. As will be appreciated from the description above, the compressed longitudinal side edges 294 of each strip of covering material has a binding material in the form of a hook-and-loop-type fastener material 300 facing in the same direction as the padding material 282 and is, therefore, exposed for attachment to the architectural surface.

As an alternative to the above, which is not illustrated, the strip of padding material could be cut longitudinally to be slightly narrower than the base layer by approximately one inch so that the base layer has exposed side edges of approximately one-half inch to which hook-and-loop material can be attached. The side edges could then be folded as described previously for the compressed edges. This alternative avoids the necessity of compressing the side edges as described above.

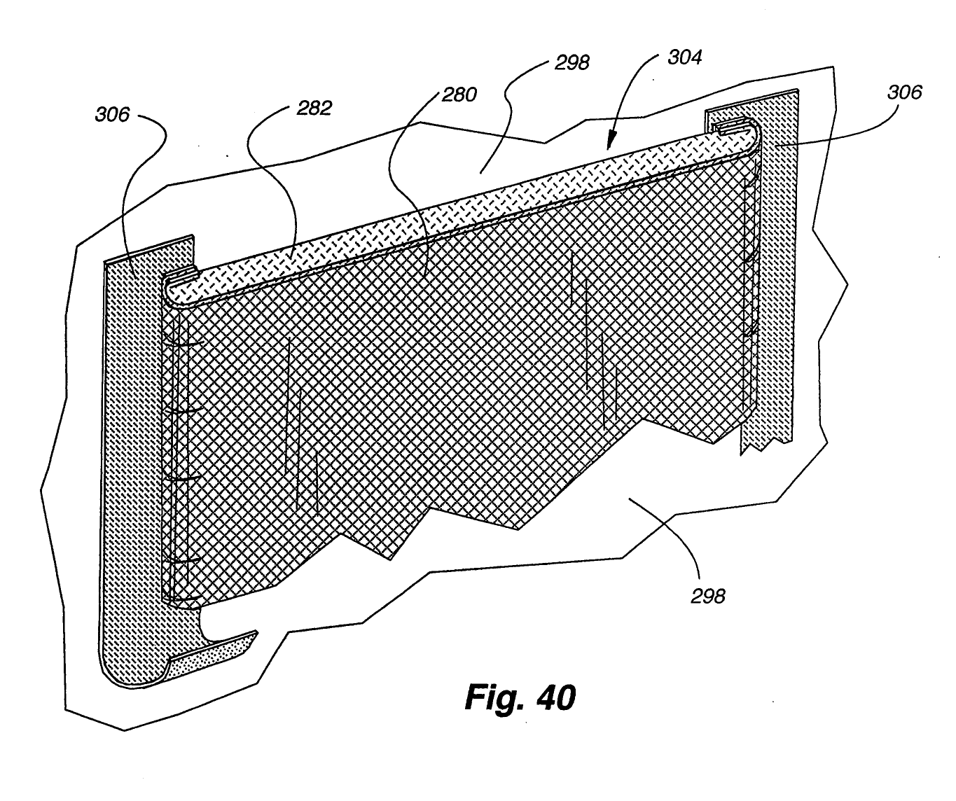

A preferred method for mounting the strips of covering material 304 on a wall of a building structure, for example, is shown in FIGS. 38-41 and includes the use of binder strips 306 of hook-and-loop material that can be adhesively or otherwise secured to the wall surface 298 at predetermined locations. The locations are selected to receive and be adhered to the hook-and-loop material along each longitudinal edge of a strip of covering material 304.

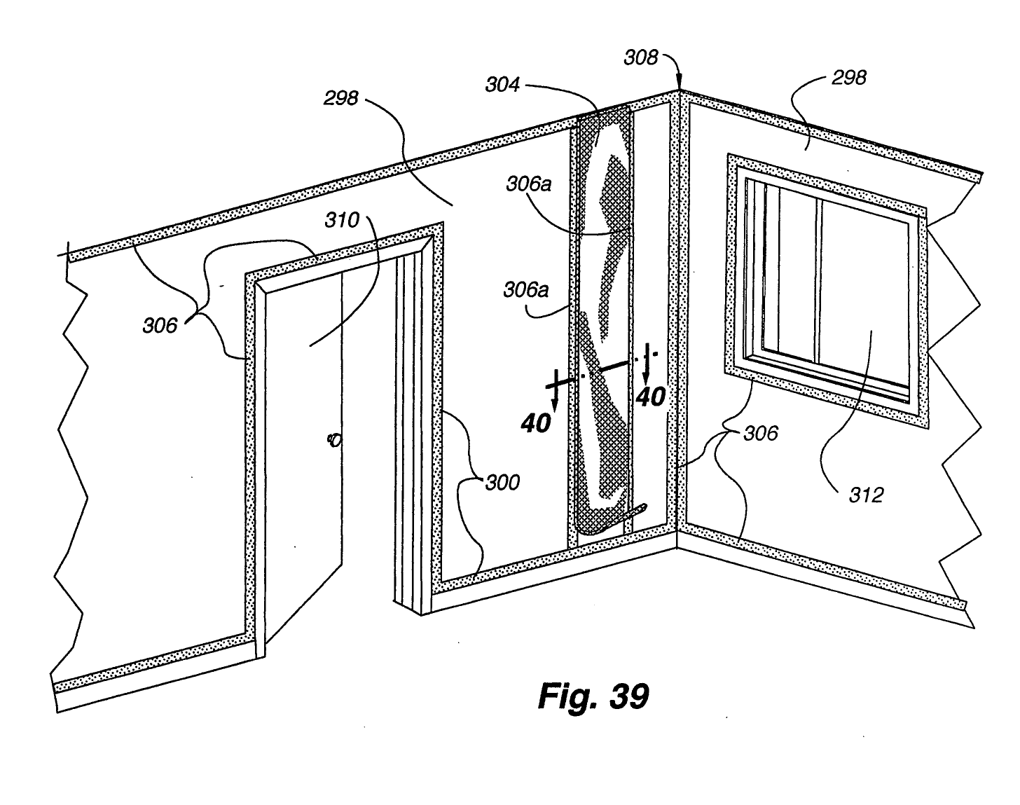

With reference to FIG. 39, the walls 298 of an architectural building are prepared initially by adhering the strips 306 of hook-and-loop material to the wall structure along the top and bottom edges thereof, as well as vertically in the corners and around door and window openings. Two additional vertical strips 306a of hook-and-loop material are next mounted at some location along a wall with the strips 306a of hook-and-loop material being spaced so as to be commensurate with the width of a strip of covering material 304 to be mounted thereon. Each strip 306 of hook-and-loop material on the wall surface is of a width to receive and secure two adjacent edges of strips of the covering material 304 so that when a strip of covering material is mounted as shown in FIG. 39, each longitudinal side edge of the strip of material can be releasably secured to the spaced vertical strips of hook-and-loop material on the wall while leaving a portion of each of the vertical strips 306 or 306a exposed for attachment to an adjacent strip of covering material.

After the first strip of covering material 304 is mounted on the wall surface, additional covering strips are mounted in contiguous adjacent relationship by progressing around a room and when encountering an interior corner as at 308, if the strip of covering material is not of full width, it can be severed along its length (not shown) and the hook-and-loop material 306 on the wall will adhere to the padding material 282 so as to hold the strip of covering material in position. The same procedure can be followed along the vertical edges of doors and windows and since most doors and windows are framed, there is a molding strip such as of wood against which the side edge of the covering material can be engaged to conceal the side edge which may not be folded.

FIG. 38 illustrates one edge of a strip of covering material 304 secured to a wall surface 298 with a strip of hook-and-loop material 306 on the wall surface secured to the hook-and-loop material 300 on the folded edge of the strip of covering material. The room illustrated in FIG. 39 is shown completed in FIG. 41 with contiguous strips of covering material mounted along the walls and around the door 310 and window 312.

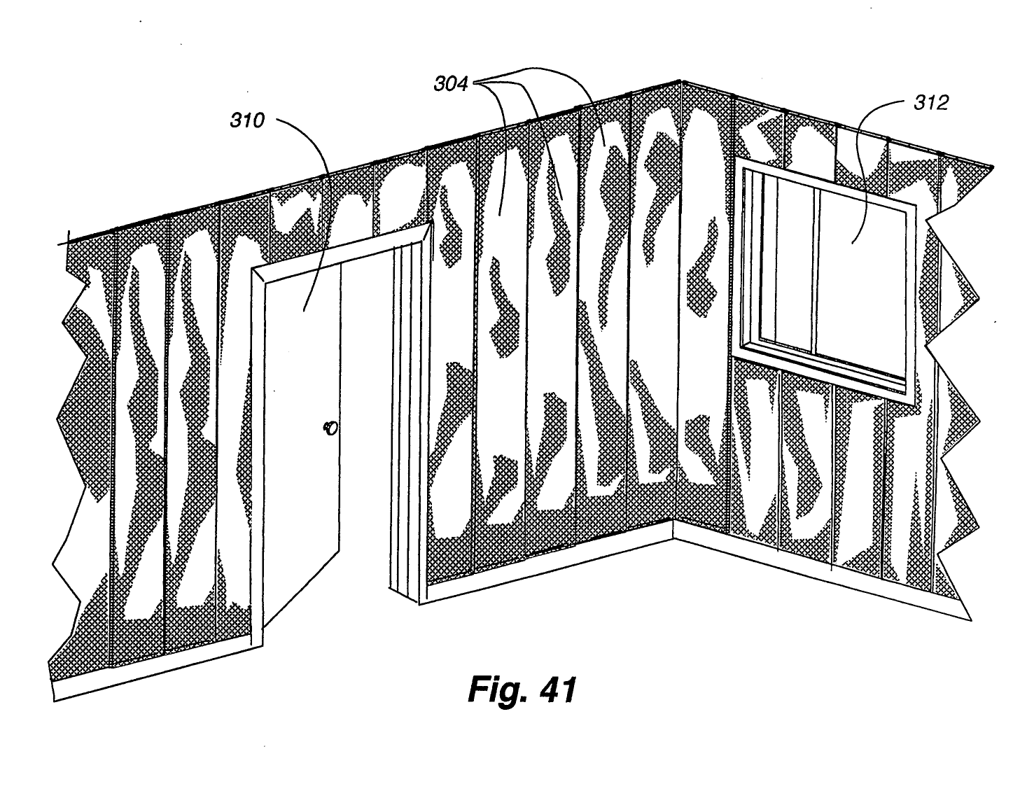

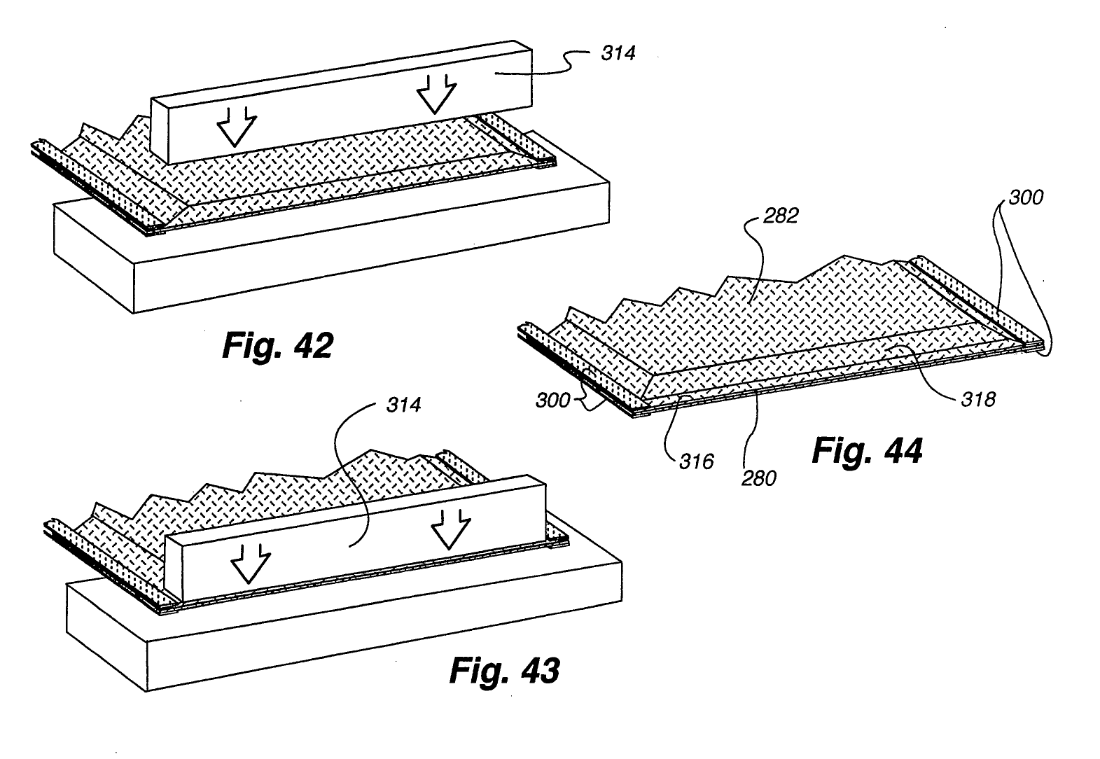

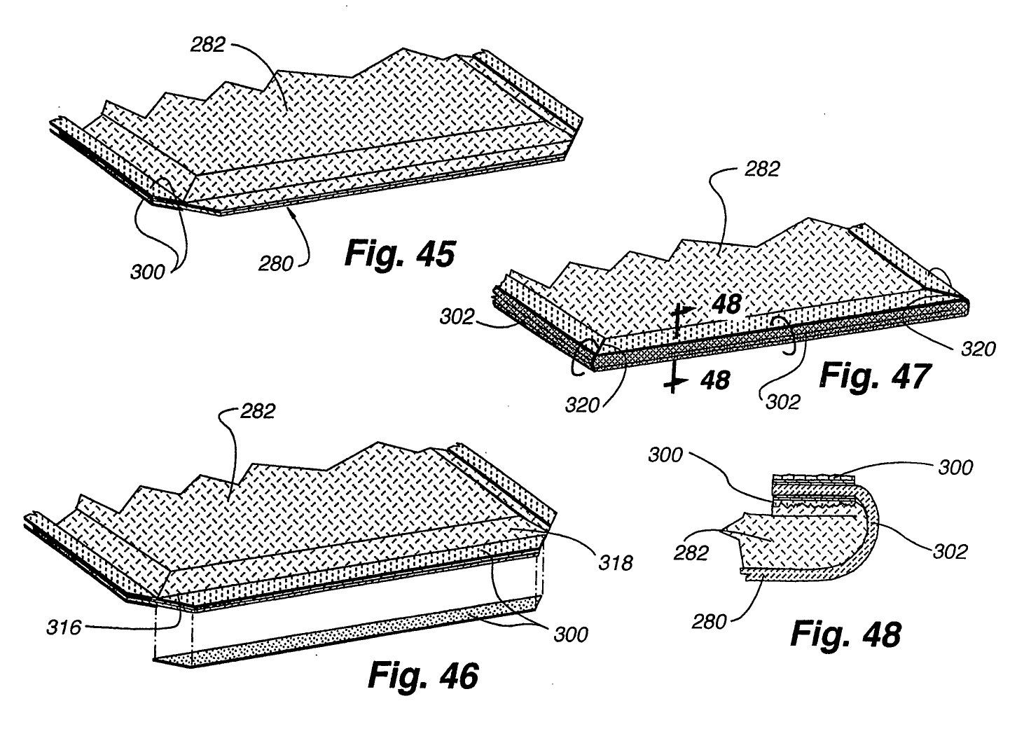

As will be appreciated from the description above, while the compressed longitudinal edges 294 of a strip of covering material 304 in accordance with the invention are folded over to provide a finished look, the end edges 288 of a strip are unfinished so the padding material 282 is exposed and could be aesthetically distractive if not hidden from view. Accordingly, as shown in FIG. 42-48, the end edges 288 of a strip of covering material 304 can be heat pressed with a press 314 to form a flattened zone 316 and an adjacent bevel surface 318 similar to the longitudinal edges 294. The base sheet 280 along the end edges can then be folded and adhered to the padding material 282 with strips of hook-and-loop material 300 the same as the longitudinal edges. After an end edge has been compressed as illustrated sequentially in FIGS. 42 and 43, the end of the sheet of covering material will have the appearance shown in FIG. 44. To provide a finished fold along the corners of the strip of covering material, however, each corner can be cut diagonally as at 318 and shown in FIG. 45 so that when the end edge 288 is folded upwardly onto the padding 282 as shown in FIG. 47, the folded longitudinal edges 294 and end edges will define a mitered joint which is smooth and will not detract aesthetically from the strip of covering material when mounted on an architectural surface.

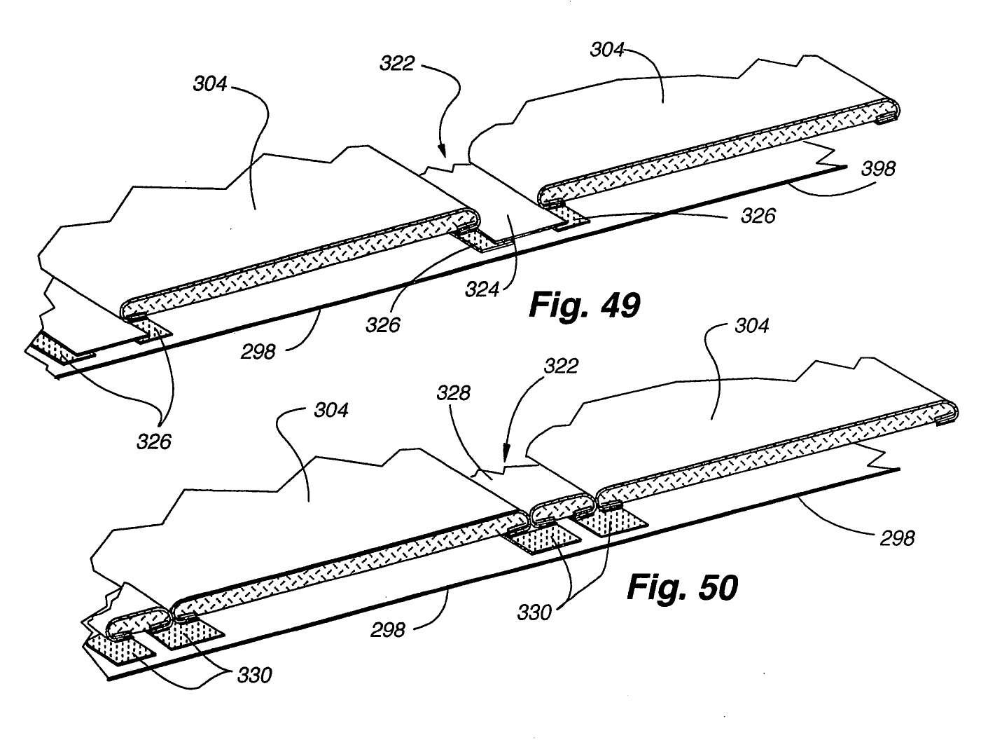

FIG. 49 shows an alternative way of mounting strips of covering material 304 on a wall surface and particularly wherein the strips of covering material are mounted in spaced relationship so as to define a reveal space 322 between adjacent strips of covering material 304. The reveal space is filled with a flat decorative strip of material 324 such as fabric, wood, aluminum or the like. When mounting the decorative strips 324 in accordance with this embodiment, relatively wide strips of hook-and-loop material (not seen) would be mounted on the architectural surface at spacings that are substantially commensurate with the width of a strip of covering material 304 and the strip of reveal material 324 would have hook-and-loop material on its rear face which is releasably connected to the hook-and-loop material on the architectural surface. The side edges of adjacent strips of covering material 304 are also releasably connected to the relatively wide strips of hook-and-loop material as illustrated. Mounting the strips of covering material 304 with reveal spaces 322 as shown provides a distinct appearance from that wherein the adjacent strips of covering material are mounted in contiguous relationship as described previously, but note as seen in FIG. 49 that the edges of the reveal strip are hidden by the folded side edges of the strips of covering material 304.

FIG. 50 illustrates still another way of mounting strips of covering material 304 in accordance with the present invention on an architectural surface 298 where again a reveal space 322 is provided between adjacent strips 304 but wherein the reveal space is filled with a padded reveal strip 328 rather than the flat strip 324 shown in FIG. 49. In this arrangement, pairs of strips 330 of hook-and-loop material would be secured to the architectural surface 298 in adjacent side-by-side relationship with each strip 330 of hook-and-loop material being of a width to receive and secure one edge of a strip of covering material 304 and one edge of the padded reveal strip 328 so the padded reveal strip is engaged with adjacent strips of covering material again providing a look that is different from those previously described.

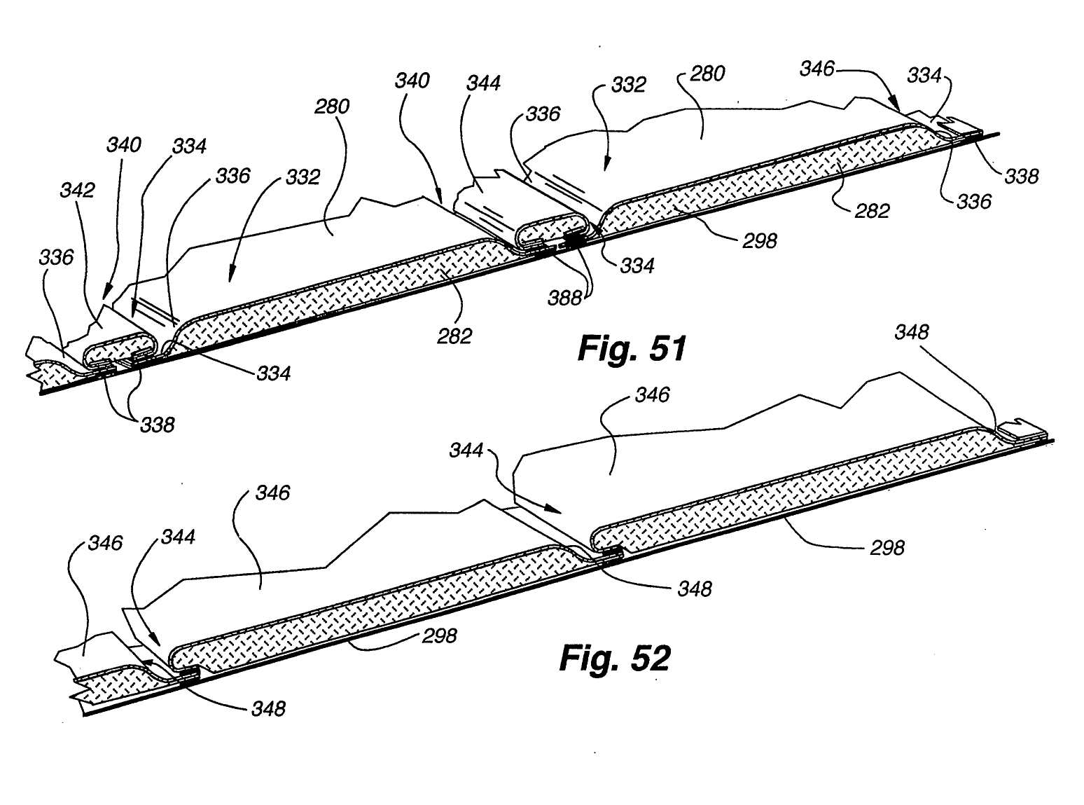

Still a further embodiment of the present invention is shown in FIG. 51. In this embodiment, strips of covering material 332 are formed differently from the strips of covering material 304 in that the side edges of each strip of covering material 332 has been formed and finished differently. In this arrangement, rather than compressing the longitudinal side edges of the laminate from the padding side toward the base layer, the laminate is inverted as suggested previously so the heat press (not shown) engages the base layer 280 and compresses it against the padding layer 282. Again, a relatively thin compressed zone 334 is defined along each longitudinal edge of a strip of covering material, but it is done in a manner to provide a contoured side edge 336 that exposes the base layer 280. Rather than folding the compressed zones 334 around the padding material 282 and securing the edges to the padding material, the compressed zones 334 are left extending laterally along the longitudinal edges of a strip of covering material 332 and those lateral compressed edges are mounted on the architectural surface 298 with hook-and-loop material 338 as described previously with the compressed longitudinal edges of adjacent strips of covering material being positioned adjacent to each other thereby defining a trough 340 along the seam between adjacent strips of covering material. A strip of padded reveal material 342 is then mounted in the trough again with the use of hook-and-loop material that has been mounted on the top surface of each compressed edge of a strip of covering material and along adjacent bottom edges of the padded reveal material.

FIG. 52 illustrates still another embodiment of the present invention wherein one folded longitudinal edge 344 of a strip of covering material 346 is formed as described in FIGS. 27-35 while the opposite laterally extending longitudinal edge 348 is formed as described in FIG. 51 and the strips of covering material 346 are then mounted in adjacent overlapping relationship so a folded edge 344 of one strip of covering material overlies and is secured to the lateral extending edge 348 of the next adjacent strip of covering material and again hook-and-loop material is utilized to secure the laterally extending edges of each strip of covering material to the architectural surface and the folded edge of one strip of covering material to the laterally extending edge of the adjacent strip of covering material.

From the above, it will be appreciated that a covering for architectural surfaces and method for forming and applying the covering has been described in a plurality of different embodiments and arrangements but wherein fabric can be used for aesthetic and acoustical purposes and wherein cells are defined to provide a three-dimensional appearance and further wherein folds or reveal materials can be used to conceal seams along adjacent strips of the covering material. Accordingly, the covering can assume many different aesthetics while providing controllable acoustical properties and concealing seams which are typically distractive in wallpapers from an aesthetic standpoint. It will be appreciated that several embodiments have been described but many variations thereon that may be provided by different folding patterns or configurations and placement of overlay strips are contemplated within the present invention.

Although the present invention has been described with a certain degree of particularity, it is understood that the present disclosure has been made by way of example, and changes in detail or structure may be made without departing from the spirit of the invention as defined in the appended claims.

What is claimed is:

1. A covering for architectural surfaces wherein the covering includes a plurality of strips of material positioned in adjacent side-by-side relationship, said strips comprising in combination:
a flexible base sheet having opposite faces and lateral edges, said lateral edges adapted to be placed adjacent to the lateral edges of base sheets of adjacent strips, one face of said base sheet being adapted to be secured to said architectural surface, and
fabric material secured to the other face of said base sheet, said fabric material having at least one fold therein and overlying a portion of said base sheet so as to form a cell between said fabric material and said base sheet, said fold being adjacent to and overlying one of said lateral edges such that when said one lateral edge is positioned on said architectural surface adjacent to a corresponding lateral edge of an adjacent side-by-side strip, the folds on the respective base sheets conceal the underlying lateral edges from view.

2. The covering of claim 1 wherein said fabric material is a single piece of material.

3. The covering of claim 1 wherein said fabric material includes a plurality of pieces of fabric material.

4. The covering of claim 2 or 3 wherein said base sheet is exposed along at least one lateral edge thereof so as to be uncovered by said fabric material.

5. The covering of claim 4 wherein one strip of material overlaps an adjacent strip of material along said uncovered lateral edge while establishing a reveal area between adjacent folds on the adjacent strips and further including a reveal material in said reveal area.

6. A covering for architectural surfaces wherein the covering includes a plurality of strips of material positioned in adjacent side-by-side relationship, said strips comprising in combination:
a flexible base sheet having opposite faces and lateral edges, said lateral edges adapted to be placed adjacent to the lateral edges of base sheets of adjacent strips, one face of said base sheet being adapted to be secured to said architectural surface, and
fabric material secured to and substantially overlying the other face of said base sheet so as to form a cell between said fabric material and said base sheet that covers less than all of said base sheet such that said fabric material and base sheet are engaged along lateral edges of said base sheet, and
reveal material secured to and overlying adjacent lateral edges of said strips of material.

7. A covering for architectural surfaces comprising in combination:
a plurality of elongated strips of material adapted to be mounted on said architectural surface, each said strip having at least one fold therein so as to define a cell between said strip of material and said architectural surface when mounted on the architectural surface.

8. The covering of claim 7 wherein said strips have lateral edges and said lateral edges are overlapped.

9. The covering of claim 8 wherein at least one lateral edge of each strip is folded upon itself and overlies the lateral edge of an adjacent strip so as to conceal the lateral edges of the adjacent strips.

10. A covering material for an architectural surface comprising in combination:
an elongated base layer of sheet material, having first and second surfaces, and longitudinal edges, said second surface being adapted to be secured to said architectural surface; and
a secondary layer of relatively thick padding material, said secondary layer being laminated to said first surface of said base layer over a majority of said first surface of the base layer so as to define relatively thin laminated longitudinal edges,
said laminated longitudinal edges being folded longitudinally and secured to said secondary layer such that said second surface of said base layer is exposed along said laminated longitudinal edges.

11. The covering material of claim 10 wherein said laminated longitudinal edges have a binder material thereon adapted to be adhered to said secondary layer adjacent to said longitudinal edges.

12. The covering material of claim 11 wherein said binder material is a hook-and-loop-type fastener.

13. The covering material of claim 10 wherein said covering is secured to said architectural surface with a hook-and-loop-type fastener system.
